(19) United States
(12) Patent Application Publication
(10) Pub. No.: US 2026/0025228 A1
(43) Pub. Date: Jan. 22, 2026

(54) METHODS, ARCHITECTURES, APPARATUSES AND SYSTEMS FOR PACKET LEVEL RATE MATCHING

(71) Applicant: InterDigital Patent Holdings, Inc., Wilmington, DE (US)

(72) Inventors: Ahmed Almradi, Ipswich (GB); Ayesha Ijaz, Guildford (GB); Patrick Tooher, Montreal (CA); Yifan Li, Conshohocken, PA (US); Pascal Adjakple, Great Neck, NY (US); Benoit Pelletier, Roxboro (CA); Ghyslain Pelletier, Montreal (CA)

(21) Appl. No.: 18/776,636

(22) Filed: Jul. 18, 2024

(51) Int. Cl. H04L 1/00

(52) U.S. Cl. CPC H04L 1/0057; H04L 1/0067

(57) ABSTRACT

Procedures, methods, architectures, apparatuses, systems, devices, and computer program products for packet level rate matching. A wireless transmit/receive unit, WTRU, determines a set of candidate outer coded code blocks, CBs, based on a determined packet level redundancy version, RV, for a transmission, wherein each outer coded CB is a different linearly independent combination of a set of source CBs, a source CB being a segment of a transport block, selects a determined number of outer coded CBs to transmit, the outer coded CBs selected from the set of candidate outer coded CBs resulting from a generated packet level mother code, and transmits the selected outer coded CBs.

### BACKGROUND

The present disclosure is generally directed to the fields of communications, software and encoding, including, for example, to methods, architectures, apparatuses, systems directed to packet level rate matching.

### SUMMARY

In a first aspect, the present principles are directed to a method in a wireless transmit/receive unit, WTRU, the method comprising determining a set of candidate outer coded code blocks, CBs, based on a determined packet level redundancy version, RV, for a transmission, wherein each outer coded CB is a different linearly independent combination of a set of source CBs, a source CB being a segment of a transport block, selecting a determined number of outer coded CBs to transmit, the outer coded CBs selected from the set of candidate outer coded CBs resulting from a generated packet level mother code, and transmitting the selected outer coded CBs.

In a second aspect, the present principles are directed to a wireless transmit/receive unit, WTRU, comprising at least one processor configured to determine a set of candidate outer coded code blocks, CBs, based on a determined packet level RV for a transmission, wherein each outer coded CB is a different linearly independent combination of a set of source CBs, a source CB being a segment of a transport block, select a determined number of outer coded CBs to transmit, the outer coded CBs selected from the set of candidate outer coded CBs resulting from a generated packet level mother code, and transmit the selected outer coded CBs.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates network coding as a protocol or function in the physical layer (PHY) in a protocol stack;

FIG. 3 illustrates a flowchart of a method according to a first embodiment of the present principles;

FIG. 4 illustrates a table (Table 1) with an example of a network coding configuration with a number of configuration sets in support of packet level rate matching according to an embodiment of the present principles;

FIGS. 5A and 5B respectively illustrate a first and a second example of a packet level mother code structure;

FIG. 6 also illustrates a flowchart of a method according to the first embodiment of the present principles;

FIG. 7 illustrates a flowchart of a method according to a second embodiment of the present principles;

FIG. 8 also illustrates a flowchart of a method according to the second embodiment of the present principles; and

FIG. 9 illustrates a first example of a method of channel coding with network coding according to a third embodiment of the present principles;

FIG. 10 illustrates a second example of a method of channel coding with network coding according to a third embodiment of the present principles;

FIGS. 11A-11C illustrate example outer coded CB formats according to the present principles;

FIG. 12 (made up of FIGS. 12A and 12B) illustrates a flowchart of a method according to the third embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

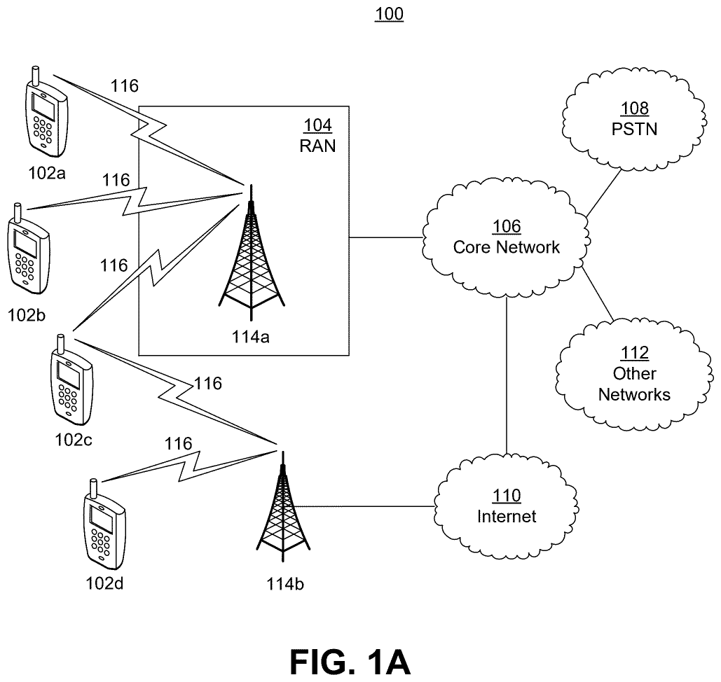

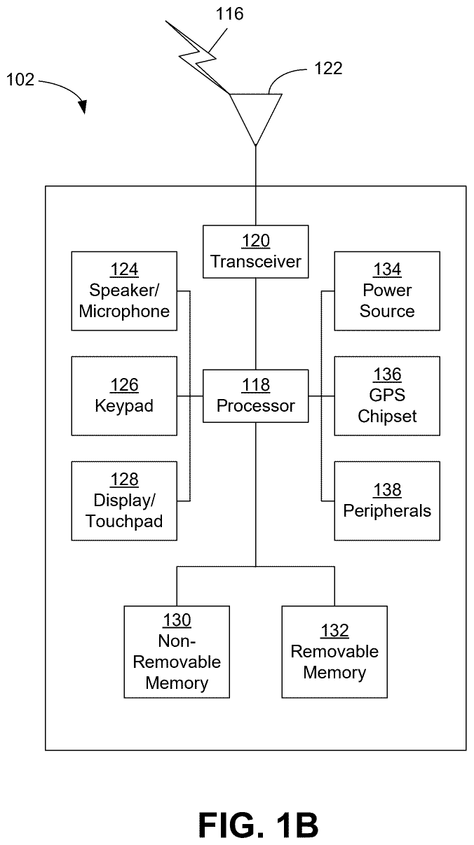

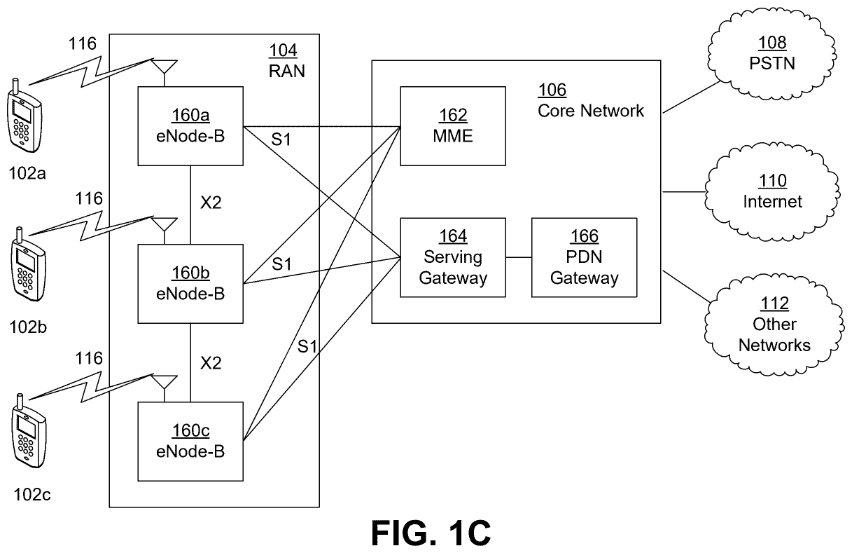

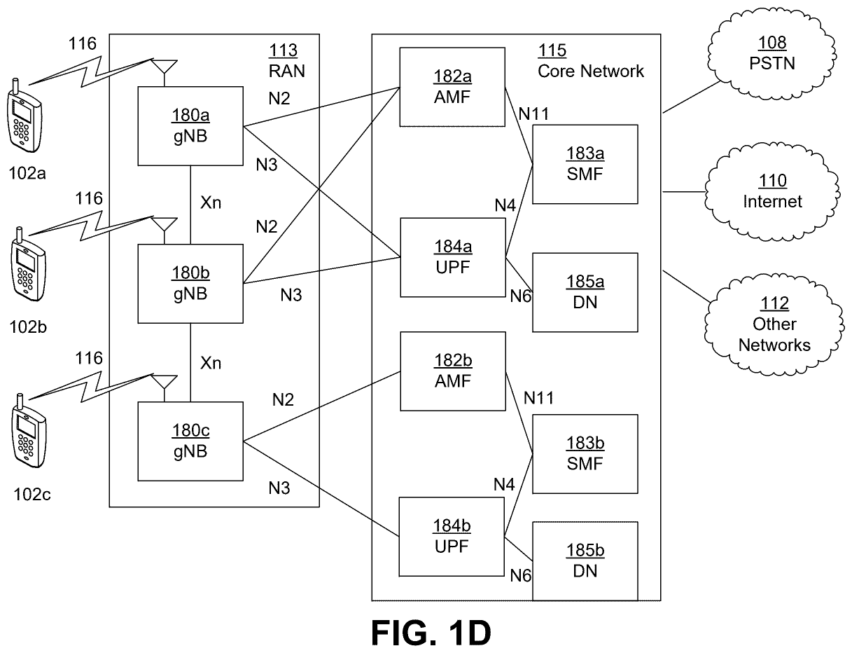

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Network coding (NC) is a packet processing function that transforms K input packet(s) (also called as source packets) into N output packet(s) (hereinafter called coded packet(s)). In general, K is greater than or equal to 2 and N is greater or equal to K, whereas both K and N equal to 1 is a special case. The K input packets that are coded together form a network coding generation (hereinafter called NC generation or simply generation), where K also denotes the generation size. An input packet to NC processing, i.e. an NC Service Data Unit (SDU) may be an upper layer SDU or a segment of an upper layer SDU. A NC processing output packet is denoted NC Protocol Data Unit (PDU). Network coding can thus be said to be a packet processing function that transforms K NC SDU(s) into N NC PDUs, where each NC PDU results from a different linearly independent combination of the NC SDUs that form the NC generation being encoded into NC PDUs. In other words, a first NC PDU generated using the NC generation is obtained based on a first linear combination of the set of NC SDUs using a first set of coding coefficients, and a second PDU generated using the NC generation is obtained based on a second linear combination of the set of NC SDUs using a second set of coding coefficients that are different from the first set of coding coefficients. The first NC PDU (i.e. the first linear combination of the set of NC SDUs) and the second NC PDU (i.e. the second linear combination of the set of NC SDUs) are linearly independent. The NC PDUs associated with the same generation, i.e. generated using the same generation, may have the same or different characteristics, and therefore be associated with the same or different importance/priority levels. Such characteristics may be systematic packets, coded packets, less-innovative coded packets, more-innovative coded packets, size of a NC SDU of the generation for example in number of bits or octets, size of the NC PDU (for example in number of bits or octets), size of a coding coefficient (for example in number of bits or octets), etc. Furthermore, there may be dependencies between NC PDUs of the same generation in the sense that: a) the receiver needs to receive correctly (i.e. successfully decode) K linearly-independent NC PDUs or more to recover the K NC SDUs, b) the number of further NC PDUs or specific NC PDUs that are needed by the receiver to recover the K NC SDUs may depend on the NC PDUs already successfully decoded by the receiver, and c) the scheduling of the NC PDUs of the same generation is constrained by the same overall delay budget.

From the receiver perspective, when it has received at least K out of N transmitted NC PDUs, it can recover the transmitted information, i.e. the K NC SDUs. As a result, even if the receiver fails to successfully decode all received NC PDUs but has decoded K NC PDUs, it can still recover the NC SDUs.

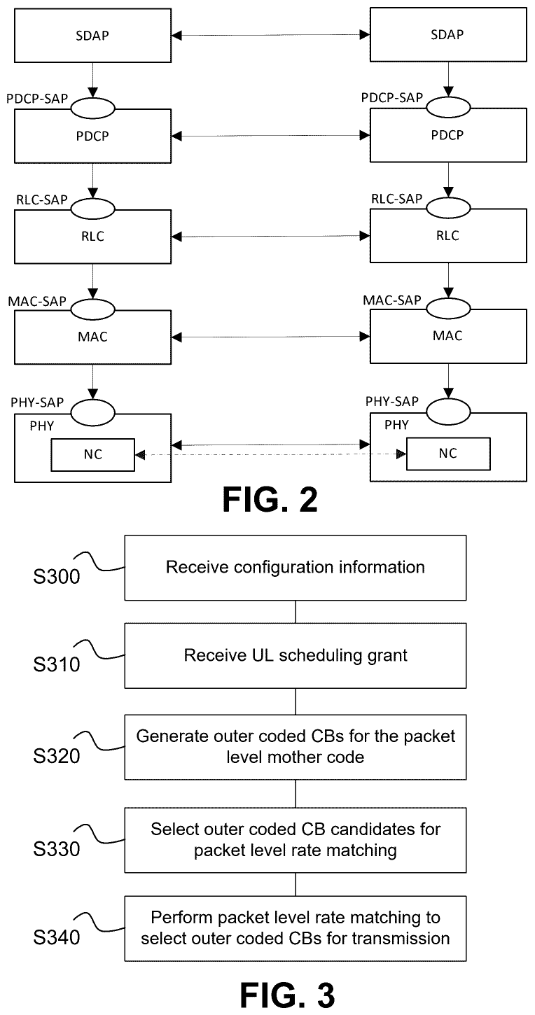

FIG. 2 illustrates network coding as a protocol or function in the physical layer (PHY) in a protocol stack. In this case, a NC SDU is a Code Block (CB), i.e. a segment of a Transport block (TB), submitted to the PHY by the Medium Access Control (MAC) layer can herein be denoted “source coded block” and a NC PDU can be denoted “Coded Code Block (CCB)” or “outer coded CB”.

While this is not the case in for example present 5G NR, network coding may be introduced directly at the PHY layer as an outer erasure code to the PHY channel coding. This could enhance the Hybrid Automatic Repeat reQuest (HARQ) ability to limit or avoid TB erasure and hence upper layer PDU erasure, which could be particularly useful for latency-sensitive applications where retransmission at the upper layers of PDUs contributing to the TB might take longer time. In some instances, the base station may fully control network coding parameters including the exact network coding rate and the characteristics (e.g. importance, systematic packets, non-systematic packets, etc.) of the outer coded CBs for any given transmission. In other instances, the base station may control how the network coding is performed but leave some flexibility for the UE to determine certain coding parameters e.g., the exact network coding rate and the characteristics of the outer coded CBs. In these approaches, an issue that may arise is how the UE performs packet level (i.e. outer coded CB level) rate matching to select a subset of generated outer coded CBs as a function of the scheduled resources for PUSCH data transmission.

The present principles address this issue.

A UE generates a fixed number of redundant outer coded CBs according to a configured erasure correction mother code rate e.g. determined based on the received Downlink Control Information (DCI) grant. The UE then performs packet level rate matching function to select a subset of these outer coded CBs for PUSCH data transmission, e.g., based on a fixed pre-determined rule.

In this disclosure, “systematic outer coded CB” (systematic NC PDU) refers to an outer coded CB that represents one of the source CBs (i.e., no outer coding function is applied to generate a systematic outer coded CB).

In this disclosure, “innovative outer coded CB” (innovative NC PDU) refers to an outer coded CB that is linearly independent from previously transmitted or received outer coded CBs. In other words, the terms “innovative outer coded CB” and “linearly independent outer coded CB” are used interchangeably herein. An outer coded CB may be designated “more-innovative outer coded CB” or “less-innovative outer coded CB”.

In this disclosure, “more-innovative outer coded CB” refers to an outer coded CB that includes information about a larger number of source CBs when compared to a less-innovative outer coded CB. In other words, an outer coded block CB1 is more innovative than an outer coded block CB2, if CB1 is coded as a linearly independent combination of K1 source CBs, CB2 is coded as a linearly independent combination of K2 source CBs, and K1 is greater than K2. In yet another implementation, a threshold denoted herein Kᵢₙₙₒᵥₐₜᵢᵥₑ may be defined. An outer coded block CB1 is more innovative if the outer coded block CB1 is coded as a linearly independent combination of at least source Kᵢₙₙₒᵥₐₜᵢᵥₑ source CBs. More-innovative outer coded CB is considered herein as higher priority or higher importance outer code CB.

In this disclosure, “less-innovative outer coded CB” refers to an outer coded CB that includes information about a smaller number of source CBs when compared to a more-innovative outer coded CB. In other words, an outer coded block CB1 is less innovative than an outer coded block CB2, if CB1 is coded as a linearly independent combination of K1 source CBs, CB2 is coded as a linearly independent combination of K2 source CBs, and K/is smaller than K2. In yet another implementation, a threshold denoted herein Kᵢₙₙₒᵥₐₜᵢᵥₑ may be defined. An outer coded block CB1 is less innovative if the outer coded block CB1 is coded as a linearly independent combination of less than Kᵢₙₙₒᵥₐₜᵢᵥₑ source CBs. Less-innovative outer coded CB is considered herein as lower priority or lower importance outer code CB.

In this disclosure, “redundant outer coded CB” refers to an extra outer coded CB that may not be required for recovering the source CBs at the receiver. For instance, when performing NC, a UE may generate extra redundant outer coded CBs, and may then send one or more of these redundant outer coded CBs for the purpose of recovering the source CBs at the receiver, e.g. as a protection against packet erasures. A redundant outer coded CB could be a systematic outer coded CB, a less innovative outer coded CB, or a more innovative outer coded CB.

In this disclosure, the terms identifier, index, codepoint, and indication in relation with an information element or a configuration parameter are used interchangeably as a reference to the said information element or configuration parameter.

In this disclosure, information received in an UL scheduling grant may mean information received in a DCI carrying scheduling grant for transmission of coded CBs. Information received in an UL scheduling grant may also mean information received in another DCI received after the reception of initial configuration information and before reception of a DCI carrying a scheduling grant for transmission of coded CBs. Information received in an UL scheduling grant may also mean information received in another DCI received after the reception of initial configuration information and before PUSCH transmission occasion for transmission of coded CBs. Information received in an UL scheduling grant may also mean information received by any other signaling mechanism (e.g. RRC, MAC CE, DCI, or a combination thereof) after the reception of initial configuration and before PUSCH transmission of coded CBs.

FIG. 3 illustrates a flowchart of a method according to a first embodiment of the present principles.

In step S300, initial configuration information is received (e.g. via RRC) by a UE. The UE typically uses the configuration information to configure itself. It is noted that the description of step S300 can also apply to configuration of the UE in the second and third embodiments of the present principles.

The configuration information can include information for one or more sets of network coding configurations, a set of configuration information includes one or more of an identifier of the configuration set, an erasure correction mother code rate, a generator matrix of coding coefficients, wherein each coding coefficient row in the generator matrix includes one or more coding coefficients, and each coding coefficient row is associated with an order sequence number (SN), one or more packet level redundancy versions (RVs) (for each packet level redundancy version, one or more corresponding coding coefficient rows, and one or more corresponding coding coefficient columns from the generator matrix, which will be used to generate outer coded CBs for this packet level redundancy version), one or more target erasure correction code rates, one or more packet level mother code structures, where each packet level mother code structure represents how the outer coded CBs of the packet level mother code are organized within the packet level mother code, e.g., the outer coded CBs of the packet level mother code may be structured into a number of overlapping and/or non-overlapping subsets of outer coded CBs wherein each subset of outer coded CBs may correspond to a given packet level redundancy version.

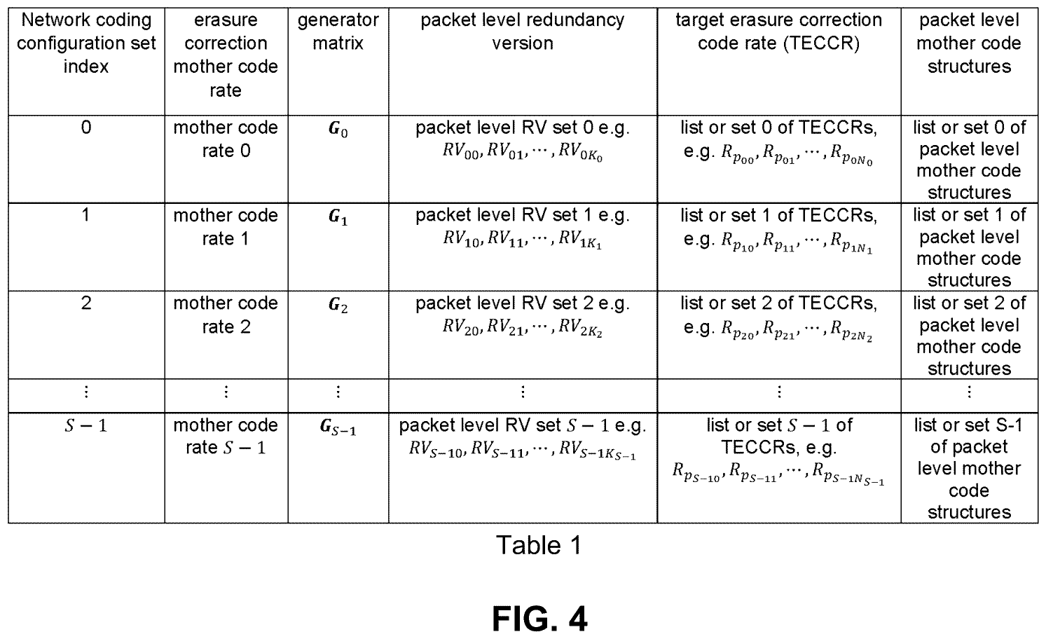

FIG. 4 illustrates a table (Table 1) with an example of a network coding configuration with a number of configuration sets in support of packet level rate matching.

In one alternative, one or more network coding configuration parameters may be configured into the UE with explicit values, as illustrated in Table 1. In another alternative, one or more network coding configuration parameters may be configured into the UE with implicit values i.e. the UE derives such configuration parameters from other configuration parameters whose values are explicitly configured into the UE. An example of implicit target erasure correction code rate configuration will be described later.

The i^{th} generator matrix with arbitrary size may be defined as

$${G}_{i} = [ \begin{matrix}{α}_{1 , 1} & {α}_{1 , 2} & … & {α}_{1 , {N}_{2}} \\ {α}_{2 , 1} & {α}_{2 , 2} & … & {α}_{2 , {N}_{2}} \\ ⋮ & ⋮ & ⋱ & ⋮ \\ {α}_{{N}_{1} , 1} & {α}_{{N}_{1} , 2} & … & {α}_{{N}_{1} , {N}_{2}}\end{matrix} ]$$

where α_{j,k}∈GF(2^{m}) is the coding coefficient, where GF(2^{m}) denotes a Galois field (binary extension field) of order 2^{m} with m being a positive integer. Each coding coefficient row in the i^{th} generator matrix Gᵢ may be associated with an order sequence number (SN) based on any combination of the following examples.

In a first example, the order SN is associated with the row index of a generator matrix used to generate the outer coded CB in an ascending order, e.g. the order SN for j^{th} row is equal to j.

In a second example, the order SN is associated with the row index of generator matrix used to generate the outer coded CB in a descending order, e.g., the order SN for j^{th} row is equal to N₁−j+1 wherein N₁ is total number of rows in the generator matrix.

In a third example, each row of the generator matrix has a unique order SN based on type or characteristics of the outer coded CBs e.g. based on innovativeness of the outer coded CB.

One or more target erasure correction code rates may be explicitly configurated into the UE (for a given network coding configuration set), as illustrated for example in Table 1. In an alternative embodiment, the UE may be implicitly configured with a target erasure correction code rate for example through configuration of an effective code rate and a target error correction code rate, wherein the effective code rate is the overall channel code rate. For example, when the UE is configured with a target error correction code rate (R_{b}) and a target erasure correction code rate (Rₚ), the effective code rate is defined as

$$R = {R}_{p} {R}_{b}$$

Therefore, the UE may determine the target erasure correction code rate implicitly when the UE determines the effective code rate and the target error correction code rate.

In step S310, the UE receives an UL scheduling grant. The UL scheduling grant can be received via DCI from the network (e.g. from the base station) and it may contain one or more of the following items of information to be used for PUSCH transmission being scheduled by the received UL scheduling grant: an indication of the network coding configuration set, an indication of target erasure correction code rate, an indication of packet level redundancy version (RV) and an indication of packet level mother code structure.

In an embodiment, the UE may determine the size of one or more of these fields, i.e. the abovementioned information items, to be fixed e.g. via standard specification or pre-configured by the network.

In an embodiment, the size of one or more of these fields may be variable. The UE may determine the actual size of the field based on the set configured with maximum number of values for the parameter. For example, the bit-width of the packet level RV field, denoted herein by L₁, may be determined based on the length of the RV set configured with the maximum number of entries, i.e.

$${L}_{1} = ⌈ {log}_{2} ( {max}_{0 \leq i \leq S - 1} {K}_{i} ) ⌉ bits ,$$

where Kᵢ denotes the number of possible packet level redundancy versions for a network coding configuration set i. Similarly, the bit-width of the target erasure correction code rate field, denoted herein by L₂, may be determined based on the length of the set configured with maximum number of entries amongst the available target erasure correction code rate sets, i.e.

$${L}_{2} = ⌈ {log}_{2} ( {max}_{0 \leq i \leq S - 1} {N}_{i} ) ⌉ bits ,$$

where Nᵢ denotes the number of possible target erasure code rates for a network coding configuration set i.

The UE may receive an indication for the selected network coding configuration set in the UL scheduling grant, e.g. via a new field introduced in a DCI format scheduling PUSCH. For example, a codepoint of length L=┌log₂ S┐ bits may be received which points to a row of network coding configuration table, e.g. as shown in Table 1. In one embodiment, the UE uses the received network coding configuration set indication (e.g. identifier, index, or code point, etc.) to select a network coding configuration set from the previously received list of network configuration sets in step S310. In another embodiment, the UE may use one or more of the size or format of the DCI, the size of the PUSCH, the size of the network coding configuration set indication field, a radio condition related quality metric (e.g. a number of HARQ retransmission over an observation window) to select a network configuration set.

The UE may receive a second indication, e.g. a new field introduced in a DCI format carrying the UL scheduling grant, which may be used to indicate the target erasure correction code rate value. For example, a codepoint of size L₂ bits may be received and point to an element within a target erasure correction code rate list or set. The UE determines the target erasure correction code rate list or set based on the indicated network coding configuration set. In one embodiment, the UE uses the received target erasure correction code rate indication (e.g. identifier, index, or code point, etc.) to select a target erasure correction code rate from the list of target erasure coding rates configured for the selected coding configuration set. In another embodiment, the UE may use one or more of the size or format of the DCI, the size of the PUSCH, the size of the target erasure correction code indication field, a radio condition related quality metric (e.g. number of HARQ retransmissions over an observation window) to select a target erasure correction code rate. In yet another embodiment, the UE may determine a target erasure correction code rate based on the effective code rate and the target error correction code rate received in the UL scheduling grant.

In an alternative, the UE may receive a second identifier e.g. a new field introduced in a DCI format carrying the UL scheduling grant, to indicate the packet level RV identifier, packet level RVᵢ, e.g. to select an element from a set of packet level redundancy version identifiers. For example, a two-bit field that may be used to indicate packet level RVᵢ is shown in Table 2.

TABLE 2
An example of packet level redundancy version set.

| Packet level redundancy | Packet level |
|---|---|
| version identifier | redundancy version |
| 00 | Packet Level RV₀ |
| 01 | Packet Level RV₁ |
| 10 | Packet Level RV₂ |
| 11 | Packet Level RV₃ |

In one alternative, the existing RV fields of the DCI format may be reused. For example, a RV field may be reused to indicate packet level RV. In another embodiment, RV may be implicitly known e.g. based on pre-configured association between the retransmission number/attempt and RV to use.

The UE may receive an indication, e.g. a new field introduced in a DCI format carrying the UL scheduling grant, which may be used to indicate the packet level mother code structure. For example, a codepoint of size L₃ bits may be received and point to a structure within a list or set of packet level mother code structures. The UE determines the packet level mother code structure list or set based on the indicated network coding configuration set. In one embodiment, the UE uses the explicit packet level mother code structure indication (e.g. identifier, index, or code point, etc.) to select a packet level mother code structure from the list of packet level mother code structures configured for the selected coding configuration set. In another embodiment, the UE uses the coding configuration set indication to implicitly determine the packet level mother code structure, e.g. when there is one packet level mother code structure configured for a coding configuration set.

In step S320, in case of a new transmission, the UE generates the packet level mother code as follows. A transmission of a TB may consist of an initial transmission and one or more retransmissions. The term new transmission herein is used in reference to the initial transmission.

The UE first uses the network coding configuration set identifier received in the UL scheduling grant, to select a network coding configuration set from the configured network coding configuration sets.

The UE then uses the erasure correction mother code rate to determine the number of outer coded CBs to generate, and the generator matrix associated with the selected network coding configuration set to generate a packet level mother code containing the determined number of outer coded CBs. Each outer coded CB is generated using a row of coding coefficients in the generator matrix associated with the network coding configuration.

The UE finally assigns, to each outer coded CB of the packet level mother code, an order SN, which is the order SN associated with the row of the coding coefficients used to generate the outer coded CB.

The generation of the packet level mother code includes two distinct steps: determination of the number of outer coded CBs to generate for the packet level mother code, and generation of the outer coded CBs for the packet level mother code.

The UE can determine the number of outer coded CBs to generate for the packet level mother code based on the number of source CBs (i.e., generation size) and the erasure correction mother code rate associated with the network coding configuration set received within the UL scheduling grant. To guarantee that the number of generated outer coded CBs for the packet level mother code is an integer value, a flooring or ceiling function may be utilized as described in the following two examples.

In a first example, a flooring function may be used to determine the number of generated outer coded CBs for the packet level mother code as the greatest integer less than or equal to the number of source CBs divided by the erasure correction mother code rate. Specifically, given that the erasure correction mother code rate may be defined as R_{M}=K/N, where K is the number of source CBs, and N is the number of generated outer coded CBs for the packet level mother code. To ensure that the resultant number of generated outer coded CBs value N=K/R_{M} is always an integer value, the number of generated outer coded CBs for the packet level mother code may be determined as N=└K/R_{M}┘.

In a second example, a ceiling function may be used to determine the number of generated outer coded CBs for the packet level mother code as the smallest integer greater than or equal to the number of source CBs divided by the erasure correction mother code rate. Specifically, to ensure that the resultant number of generated outer coded CBs value N=K/R_{M} is always an integer value, the number of generated outer coded CBs for the packet level mother code may be determined as N=┌K/R_{M}┐.

The UE can generate the outer coded CBs for the packet level mother code based on the number of generated outer coded CBs for the packet level mother code determined in the previous step and the generator matrix associated with the network coding configuration set indicated in the UL scheduling grant. In this case, the outer network encoder function generates N outer coded CBs m₀, m₁, . . . , m_{N-1}, denoted packet level mother code herein, where each outer coded CB within the packet level mother code is generated using a row of coding coefficients in the generator matrix.

The UE assigns, to the outer coded CB, respective order SN (as received in the configuration of the selected network coding configuration set) of the raw of coding coefficients used to generate the outer coded CB and interpret the order SN of the outer coded CB as described in the following two examples.

Increasing order SN of outer coded CBs corresponds to increasing priority or importance of the outer coded CBs. In other words, decreasing order SN of outer coded CBs corresponds to decreasing priority or importance of the outer coded CBs.

Increasing order SN of outer coded CBs corresponds to decreasing priority or importance of the outer coded CBs. In other words, decreasing order SN of outer coded CBs corresponds to increasing priority or importance of the outer coded CBS.

The order SN may be associated with the type of the outer coded CBs, e.g. order SN is first assigned to a first set of systematic outer coded CBs and then to a second set of non-systematic outer coded CBs.

The packet level mother code may be structured in different ways, as will now be described.

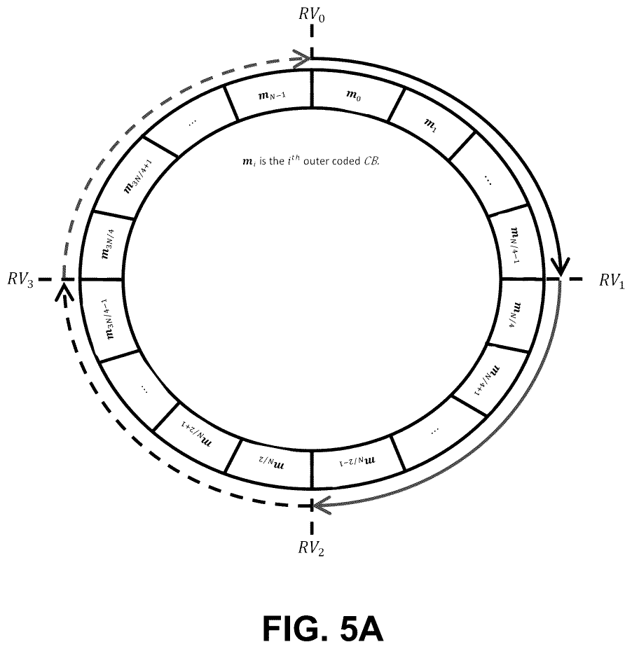

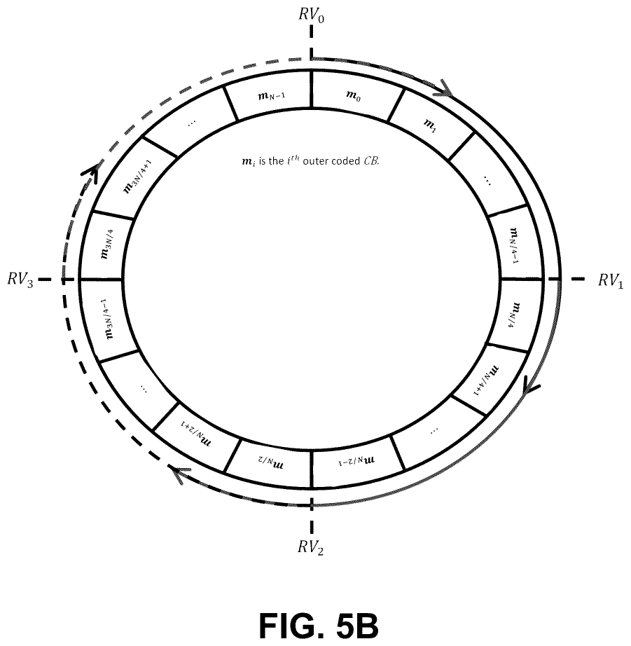

In a first embodiment, the outer coded CBs of the packet level mother code may be placed in a packet level circular buffer, where the packet level mother code is divided into a number of disjoint non-overlapping subsets, where each subset represents the outer coded CBs of the packet level mother code that belongs to one of the packet level RVs. FIG. 5A illustrates a first example of a packet level mother code structure in which packet level RV₀ is assigned a first subset of the outer coded CBs of the packet level mother code sequentially starting from the first outer coded CB,

$${m}_{0} , {m}_{1} , … , {m}_{\frac{N}{4} - 1} ,$$

packet level RV₁ is assigned a second disjoint subset of the outer coded CBs of the packet level mother code sequentially starting from the outer coded CB,

$${m}_{\frac{N}{4}} , {m}_{\frac{N}{4} + 1} , … , {m}_{\frac{N}{2} - 1} ,$$

and so on.

In a second embodiment, the outer coded CBs of the packet level mother code may be placed in a packet level circular buffer, where the packet level mother code is divided into a number of overlapping subsets, where each subset represents the outer coded CBs of the packet level mother code that belongs to one of the packet level RVs. FIG. 5B illustrates a second example of a packet level mother code structure in which packet level RV, is assigned a first subset of the outer coded CBs of the packet level mother code sequentially starting from the first outer coded CB,

$${m}_{0} , {m}_{1} , … , {m}_{\frac{N}{4} + Δ} ,$$

packet level RV₁ is assigned a second overlapping subset of the outer coded CBs of the packet level mother code sequentially starting from the outer coded CB,

$${m}_{\frac{N}{4}} , {m}_{\frac{N}{4} + 1} , … , {m}_{\frac{N}{2} + Δ} ,$$

and so on, where Δ represents the number of overlapping outer coded CBs.

In another embodiment (not illustrated), the order SNs of the outer coded CBs of the first subset of outer coded CBs, and the order SNs of the second subset of outer coded CBs are consecutive order SNs. In a variant, the order SNs of the outer coded CBs of the first subset of outer coded CBs, and the order SNs of the second subset of outer coded CBs are not consecutive SNs. For example, packet level RV₀ may be assigned a first subset of the outer coded CBs of the packet level mother code in a non-consecutive order starting from the first subset of outer coded CB,

$${m}_{0} , {m}_{\frac{N}{4}} , {m}_{\frac{N}{2}} … , {m}_{\frac{3 N}{4}} ,$$

whereas packet level RV₁ may be assigned a second disjoint subset of the outer coded CBs of the packet level mother code a non-consecutive order starting from the second outer coded CB,

$${m}_{1} , {m}_{\frac{N}{4} + 1} , {m}_{\frac{N}{2} + 1} , … , {m}_{\frac{3 N}{4} + 1} ,$$

and so on.

When it comes to the determination of packet level mother code structure, in a first embodiment, the packet level mother code structure may be predefined (e.g. in a standard specification). In a second embodiment, a UE may be preconfigured with a list or set of packet level mother code structures, e.g. via RRC, and the UE may receive a dynamic indication to determine which structure to use, e.g., based on an indication received in an UL grant such as described with reference to step S310. In a third embodiment, the UE may receive a semi-static indication, e.g. via RRC/MAC CE/DCI, to determine which packet level mother code structure to use out of a list of preconfigured or predefined structures.

In step S330, the UE selects candidate outer coded CBs for packet level rate matching.

The UE can determine the packet level redundancy version for this transmission based on the received UL scheduling grant and determine the set of candidate outer coded CBs based on this packet level redundancy version and the selected configuration set.

In more detail, the UE can determine the set of candidate outer coded CBs based on the packet level RVᵢ indicated in the DCI carrying the UL scheduling grant. In this case, the UE may receive a first identifier indicating the network coding configuration set i indicating a packet level redundancy version set. The UE may then receive a second identifier indicating the packet level RVᵢ for the scheduled PUSCH transmission from the packet level redundancy version set. Each packet level RVᵢ is associated with one or more identifiers of the corresponding coding coefficient rows and with one or more identifiers of coding coefficient columns. Then, the UE can determine the set of candidate outer coded CBs associated with each packet level RVᵢ. For example, the UE may assign a starting packet location for each initial transmission and retransmission occasion from the available number of outer coded CBs of the packet level mother code. In this case, the UE may transmit the outer coded CBs starting from the starting packet location determined from the packet level RVᵢ. This may be used to guarantee that a new set of innovative outer coded CBs is transmitted at each transmission, i.e. the initial transmission and any subsequent retransmission. For example, joint or disjoint subsets of the outer coded CBs of the packet level mother code with consecutive or non-consecutive outer coded CBs are assigned to a set of packet level RVs are described with reference to step S320, where each packet level RVᵢ is assigned a starting packet location and a subset of the outer coded CB of the packet level mother code, m₀, m₁, . . . , m_{N-1}.

In step S340, the UE performs packet level rate matching to select outer coded CBs for transmission.

To do so, the UE first determines the number M of outer coded CBs to transmit based on the target erasure correction code rate received in the UL scheduling grant, and the candidates outer coded CBs selected in step S330. For example, M is the greatest integer that is less than or equal to the number of source CBs (i.e., the generation size) divided by the target erasure correction code rate. As another example, M is the smallest integer that is greater than or equal to the number of source CBs (i.e., the generation size) divided by the target erasure correction code rate.

The UE then selects M outer coded CBs to transmit from the candidate outer coded CBs according to the order SNs of the candidate outer coded CBs.

The UE finally submits the selected outer coded CBs to PHY layer channel coding processing (e.g. Low-Density Parity Check Code (LDPC)) for processing and transmission.

In more detail, the packet level rate matching may include two distinct sub-steps: 1) determination of the number of outer coded CBs to transmit, and 2) selection of the outer coded CBs to transmit.

In the first sub-step, the UE can determine the number M of outer coded CBs to transmit based on the number of source CBs (i.e., generation size) and the target erasure correction code rate indicated within the UL scheduling grant. In this case, the UE may receive a first identifier indicating a network coding configuration set i. The UE may also receive a second identifier indicating a target erasure correction code rate value from a target erasure correction code rate table or set. To guarantee that M is an integer value, a flooring or ceiling function may be utilized as will be described.

A flooring function may determine the number of outer coded CBs to transmit as the greatest integer less than or equal to the number of source CBs divided by the target erasure correction code rate. In this case, given that the target erasure correction code rate is Rₚ=K/M, where K is the number of source CBs (i.e. the NC generation size), and M is the number of outer coded CBs to transmit. To ensure that the resultant number of outer coded CBs to transmit, i.e. M=K/Rₚ, is an integer value, it could be determined as M=└K/Rₚ┘.

A ceiling function may determine the number of outer coded CBs to be transmitted as the smallest integer greater than or equal to the number of source CBs divided by the target erasure correction code rate. To ensure that the resultant M=K/Rₚ is an integer value, it could be determined as M=┌K/Rₚ┐.

In the second sub-step, the UE selects the M outer coded CBs to transmit for further lower layer processing from the candidate outer coded CBs, possibly as described in one or more of the following four examples.

In a first example, the UE selects the M outer coded CBs to transmit from the candidate outer coded CBs according to the order SNs of the candidate outer coded CBs. In this case, in one embodiment, the UE may sequentially select the M outer coded CBs to transmit from the set of candidates outer coded CBs (according to the indicated packet level RVᵢ) according to the increasing order of the order SN, e.g. starting from the first outer coded CB within the set of candidates outer coded CBs. In another embodiment, the UE may sequentially select the M outer coded CBs to transmit from the set of candidates outer coded CBs (according to the indicated packet level RVᵢ) according to the decreasing order of the order SN e.g. starting from the last outer coded CB within the set of candidates outer coded CBs.

In a second example, the UE selects the M outer coded CBs to transmit from the candidate outer coded CBs according to the (re)-transmission occasion, e.g. during the initial transmission. The UE may select the M outer coded CBs to transmit starting from the first set of systematic outer coded CBs within the candidate outer coded CBs, and then select further outer coded CBs from the second set of non-systematic outer coded CBs within the candidate outer coded CBs according to the available granted resources. During subsequent retransmissions, the UE can select the M outer coded CBs to transmit starting from the second set of non-systematic outer coded CBs from the candidate outer coded CBs.

In a third example, the UE selects the M outer coded CBs to transmit from the candidate outer coded CBs according to their characteristics e.g. level of innovativeness. The UE may select one or more combinations of less-innovative outer coded CBs and more-innovative outer coded CBs from the candidate outer coded CBs based on e.g. the number of (re)-transmissions (a first transmission, a first retransmission, a second retransmission, etc.).

In a fourth example, the UE selects the M outer coded CBs to transmit from the candidate outer coded CBs according to their importance, e.g. by considering for the remaining delay budget for the recovery of the source CBs of a generation. In this case, the UE can select the M outer coded CBs to transmit from the candidate outer coded CBs according to their importance level e.g. starting from the outer coded CBs with the highest importance, then if further resources are still available, from the outer coded CBs with medium importance, then from the outer coded CBs with low importance, etc.

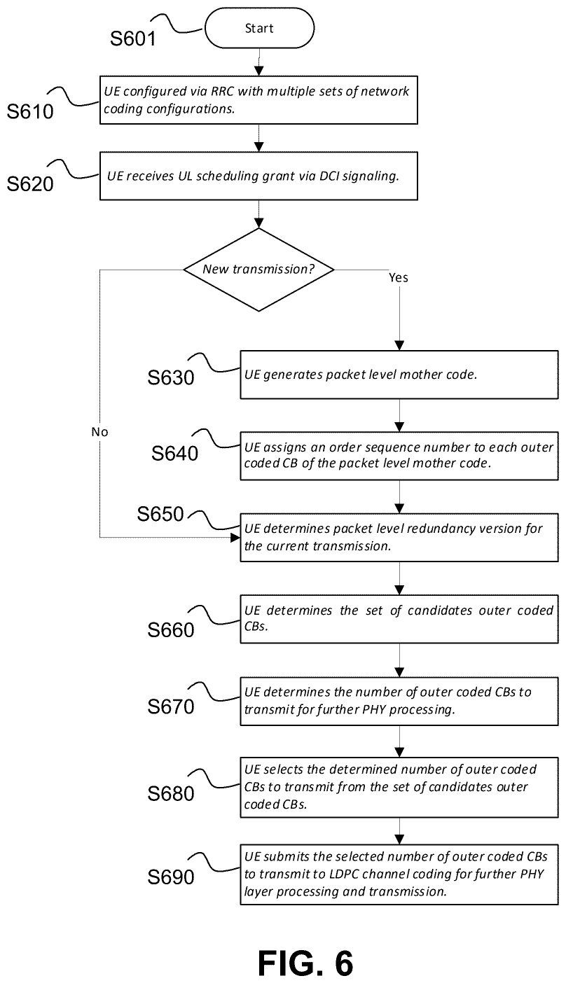

The embodiment is summed up in FIG. 6 that illustrates a flowchart of a method according to the first embodiment of the present principles.

The method starts in step S601.

In step S610, the UE is configured, e.g. via RRC, with multiple sets of network coding configurations. Each set of network coding configuration can include an identifier of the configuration set, an erasure correction mother code rate value, a generator matrix of coding coefficients, a packet level redundancy version set, where for each packet level redundancy version, one or more identifiers of the corresponding coding coefficient rows, one or more identifiers of coding coefficient columns, a target erasure correction code rate list or set, and one or more packet level mother code structures.

In step S620, the UE receives via DCI signaling an UL scheduling grant indicating a network coding configuration set, a target erasure correction code rate index value, a packet level redundancy version, and a packet level mother code structure.

In case of a new transmission, the method continues in step S630; otherwise, the method continues in step S650.

In step S630, the UE generates a packet level mother code as follows: a) the UE uses the network coding configuration set identifier received within the UL scheduling grant, to select a network coding configuration set from the configured network coding configuration sets, b) the UE uses the erasure correction mother code rate and the generator matrix associated with the selected network coding configuration set, to generate a packet level mother code containing one or more outer coded CBs, wherein each outer coded CB is generated using a row of coding coefficients in the generator matrix associated with the network coding configuration. The UE determines the number of the one or more outer coded CBs that form the packet level mother code using the erasure correction mother code rate and the number of source CBs being coded together.

In step S640, the UE assigns an order sequence number to each outer coded CB of the packet level mother code, wherein the order sequence number is the order sequence number associated with the row of the coding coefficients used to generate the outer coded CB.

In step S650, the UE determines the packet level RV for the current transmission based on the received UL scheduling grant.

In step S660, the UE determines the set of candidates outer coded CBs based on the determined packet level RV.

In step S670, the UE determines the number of outer coded CBs to transmit denoted herein as M based on the number of source CBs and the target erasure correction code rate received in the UL scheduling grant.

In step S680, the UE selects the determined number of outer coded CBs to transmit from the set of candidates outer coded CBs according to the order sequence numbers of the candidate outer coded CBs.

In step S690, the UE submits the selected number of outer coded CBs to transmit to LDPC channel coding for further PHY layer processing and transmission.

So far, the present principles have been described as being based on a packet level mother code. A second embodiment that is not based on a packet level mother code will now be described.

As a reminder, the present principles are directed to a UE performing outer coded CB level rate matching to select a subset of generated outer coded CBs for PUSCH data transmission when network coding is applied at the PHY layer.

For the uplink transmission, the UE generates a set of candidate outer coded CBs. The generation can be for example be based on a packet level redundancy version determined that in turn can be based on a received scheduling grant, i.e. in the absence of erasure correction mother code rate. In this case, for each (re)-transmission occasion, the UE generates new set of candidate outer coded CBs and then performs packet level rate matching to select the outer coded CBs to transmit from the new set according to a (e.g. pre-determined) rule.

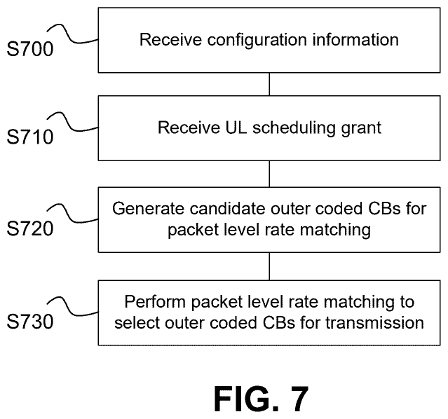

FIG. 7 illustrates a method of a second embodiment according to the present principles.

In step S700, the UE receives (e.g. via RRC) initial configuration information that it uses to configure itself with one or more sets of network coding configurations, wherein each set includes one or more of an identifier of the configuration set, a generator matrix of coding coefficients wherein each coding coefficient row in the generator matrix includes one or more coding coefficients and each coding coefficient row is associated with an order SN, one or more subsets of coding coefficients, for each coding coefficient subset, one or more corresponding coding coefficient rows and one or more corresponding coding coefficient columns from the generator matrix, which will be used to generate outer coded CBs for this coding coefficients subset, one or more target erasure correction code rates and one or more packet level mother code structures.

As mentioned, the UE may be configured with one or more network coding configuration sets, where each configuration set has a row index identifier indicating a generator matrix, a set of coding coefficients subsets, a set of target erasure correction code rates, which could be similar to those in Table 1.

In one embodiment, each network coding configuration set indicates a set of coding coefficients subsets associated with one or more corresponding coding coefficient rows, and one or more corresponding coding coefficient columns from the generator matrix, which will be used to generate outer coded CBs for this coding coefficient subset, e.g. during a (re)-transmission occasion.

In another embodiment, each network coding configuration set indicates a set of generator matrices, wherein a generator matrix identifier may be used to generate the outer coded CBs for this generator matrix, e.g. during a (re)-transmission.

In step S710, the UE receives a UL scheduling grant, e.g. via DCI from the network, including one or more of the following to be used for PUSCH transmission being scheduled by the received UL scheduling grant: an indication of the network coding configuration set, an indication of target erasure correction code rate, an indication of coding coefficients subset identifier and an indication of packet level mother code structure.

The UE may receive a second identifier to indicate the coding coefficients subset identifier, e.g. to indicate a subset from a set of coding coefficients subsets. The second identifier can for example be received in a new field introduced in a DCI format carrying the UL scheduling grant. For example, a two-bit field may be used to indicate the coding coefficients subset identifier.

In step S720, the UE generates candidate outer coded CBs for packet level rate matching.

First, the UE determines the coding coefficients subset for this transmission based on the received UL scheduling grant.

Then, the UE generates the set of candidates outer coded CBs based on the indicated coding coefficients subset and the selected configuration set.

Finally, the UE assigns an order SN to each outer coded CB, which is the order SN associated with the row of the generator matrix used to generate the outer coded CB.

The generation of the candidate outer coded CBs includes two distinct steps: determination of the coding coefficients subset and generation of the candidate outer coded CBs. In the first step, the UE determines the coding coefficients subset based on the received UL scheduling grant. In the second step, the UE generates the set of candidates outer coded CBs based on the number of source CBs and the indicated coding coefficients subset as described in one of the following two examples.

In a first example, each coding coefficient subset selects a submatrix of the generator matrix, e.g. based on the characteristics of the outer coded CBs to transmit. In this case, during the initial transmission of the first coding coefficients subset, the UE generates the first set of candidates outer coded CBs based on the first submatrix of the generator matrix, which includes the systematic outer coded CBs and possibly some of the non-systematic outer coded CBs. During a first retransmission of the second coding coefficients subset, the UE generates the second set of candidates outer coded CBs based on a second submatrix of the generator matrix, which includes non-systematic outer coded CBs, etc.

If the UE is configured with a HARQ feedback technique that reports the number of correctly received CBs, then during a retransmission, the UE generates the set of candidates outer coded CBs based on a new submatrix of the generator matrix which generates new set of non-systematic outer coded CBs, where each non-systematic outer coded CB may be generated using a set of non-zero coding coefficients row in the generator matrix. To guarantee linear independence, each coding coefficients row in the generator matrix have different set of non-zero values.

In a second example, the UE utilizes the indicated generator matrix only for the first coding coefficients subset during the initial transmission, whereas the UE adaptively constructs new set of coding coefficients (new generator matrix) during subsequent retransmissions based on the utilized HARQ Acknowledgment feedback technique.

If the UE is configured with a HARQ feedback technique based on code block group (CBG) bitmap, then during a retransmission, the UE generates the set of candidate outer coded CBs based on new set of outer coded CBs which are linear combinations of the CBs associated with the erroneous CBGs. In this case, successively received CBGs are not included within the retransmitted outer coded CBs. This technique can significantly reduce the outer network encoding and decoding complexity as only a linear combination of the erroneously received CBs are retransmitted.

In step S730, the UE uses packet level rate matching to select outer coded CBs for transmission.

To do this, the UE can first determine the number M of outer coded CBs to transmit, based on the target erasure correction code rate received in the UL scheduling grant, and the candidates outer coded CBs selected in step S520. In a first example, M is the greatest integer that is less than or equal to the number of source CBs (i.e., the generation size) divided by the target erasure correction code rate. In a second example, M is the smallest integer that is greater than or equal to the number of source CBs (i.e., the generation size) divided by the target erasure correction code rate.

The UE can then select the number of outer coded CBs to transmit from the candidate outer coded CBs according to the order SNs of the candidate outer coded CBs.

The UE can finally submit to PHY layer channel coding processing (e.g. LDPC) for processing and transmission, the selected number of outer coded CBs to transmit.

As can be seen, the UE can perform packet level rate matching and determines the number and characteristics of the outer coded CBs to transmit in an adaptive manner.

The packet level rate matching may include two distinct steps: determination of the number of outer coded CBs to transmit, and selection of the actual outer coded CBs to transmit from the set of candidates outer coded CBs. In the first step, the UE determines M based on the number of source CBs and the target erasure correction code rate, as described with reference to step S340. In the second step, the UE selects the determined number of outer coded CBs to transmit for further lower layer processing from the set of candidates outer coded CBs for instance as described in one or more of the following four examples.

In a first example, the UE selects the determined number of outer coded CBs to transmit from the candidate outer coded CBs according to the order SNs of the candidate outer coded CBs. In this case, in one embodiment, the UE may sequentially select the determined number of outer coded CBs to transmit from the set of candidates outer coded CBs (according to the indicated coding coefficients subset) according to the increasing order of the order SN, e.g. starting from the first outer coded CB within the set of candidates outer coded CBs. In another embodiment, the UE may sequentially select the determined number of outer coded CBs to transmit from the set of candidates outer coded CBs (according to the indicated coding coefficients subset) according to the decreasing order of the order SN, e.g. starting from the last outer coded CB within the set of candidates outer coded CBs.

In a second example, the UE selects the determined number of outer coded CBs to transmit from the candidate outer coded CBs according to their characteristics, e.g. level of innovativeness. The UE may select one or more of less-innovative outer coded CBs and more-innovative outer coded CBs from the candidate outer coded CBs based on e.g. the transmission occasion and/or HARQ acknowledgments feedback.

In a third example, the UE selects the determined number of outer coded CBs to transmit from the candidate outer coded CBs according to the (re)-transmission occasion, e.g. during the initial transmission, the UE selects the determined number of outer coded CBs to transmit starting from the first set of systematic outer coded CBs within the candidate outer coded CBs, then selects further outer coded CBs from the second set of non-systematic outer coded CBs within the candidate outer coded CBs according to the available granted resources. During subsequent retransmissions, the UE selects the determined number of outer coded CBs to transmit starting from the second set of non-systematic outer coded CBs from the candidate outer coded CBs.

In a fourth example, the UE selects the determined number of outer coded CBs to transmit from the candidate outer coded CBs according to their importance, e.g. by considering the remaining delay budget for the recovery of the source CBs of a generation. In this case, the UE selects the determined number of outer coded CBs to transmit from the candidate outer coded CBs according to their importance level, e.g. starting from the outer coded CBs with the highest importance, then if further resources are still available, the UE may select from the outer coded CBs with medium importance, then the UE may select from the outer coded CBs with low importance, etc.

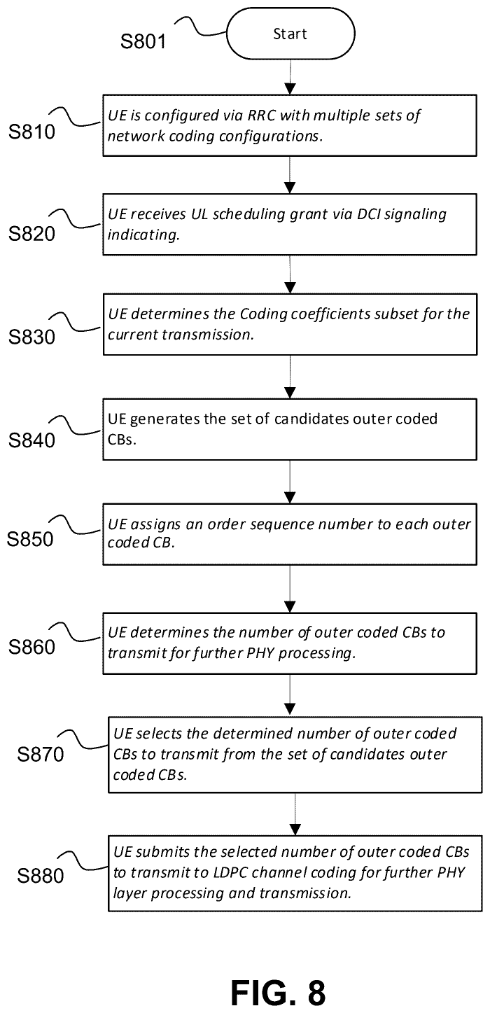

FIG. 8 also illustrates a flowchart of a method according to an embodiment of the present principles.

The method starts in step S801.

In step S810, the UE is configured, e.g. via RRC, with multiple sets of network coding configurations. Each set of network coding configuration can include an identifier of the configuration set, a generator matrix of coding coefficients, a set of coding coefficients subsets, where for each coding coefficients subset, one or more identifiers of the corresponding coding coefficient rows, and one or more identifiers of coding coefficient columns, a target erasure correction code rate list or set, and a packet level mother code structures list or set.

In step S820, the UE receives, via DCI signaling, an UL scheduling grant indicating a network coding configuration set, a target erasure correction code rate index value, a coding coefficients subset identifier, and a packet level mother code structure.

In step S830, the UE determines the coding coefficients subset for the current transmission based on the received UL scheduling grant.

In step S840, the UE generates the set of candidates outer coded CBs based on the received coding coefficients subset indicated in the received UL scheduling grant, indicating a submatrix of the selected generator matrix. Each coding coefficients subset indicates a submatrix of the indicated generator matrix e.g. based on the characteristics of the outer coded CBs.

In step S850, the UE assigns an order SN to each outer coded CB of the set of candidate outer coded CBs, which is the order SN associated to the row of the generator matrix used to generate the outer coded CB.

In step S860, the UE determines the number of outer coded CBs to transmit based on the number of source CBs and the target erasure correction code rate.

In step S870, the UE selects the determined number of outer coded CBs to transmit from the set of candidates outer coded CBs according to the order sequence numbers.

In step S880, the UE submits the selected number and outer coded CBs to transmit to LDPC channel coding for further PHY layer processing and transmission.

Summing up the second embodiment, it is directed to a UE that determines, based on a received UL scheduling grant, from a received set of coding coefficients, a coding coefficients subset for an upcoming transmission, generates a set of candidate outer coded code blocks, CBS, based on the determined coding coefficients subset that indicates a submatrix of a selected generator matrix, assigns an order sequence number, SN, to each outer coded CB of the set of candidate outer coded CBs, wherein the order SN corresponds to the row of the selected generator matrix used to generate the respective outer coded CB, determines a number of outer coded CBs to transmit based on a number of source CBs for the upcoming transmission and a target erasure correction code rate, selects the determined number of outer coded CBs to transmit from the set of candidate outer coded CBs according to the order SNs, and transmits the selected outer coded CBs.

Before the transmitting, the UE can provide the selected outer coded CBs to transmit to channel coding.

The UE can also first be configured with multiple sets of network coding configurations. Each set of network coding configurations comprises at least one of an identifier of the configuration set, a generator matrix of coding coefficients, a set of coding coefficients subsets, each comprising one or more identifiers of the corresponding coding coefficient rows and one or more identifiers of the corresponding coding coefficient columns, and a target erasure correction code rate list or set.

The UE can also receive, possibly via Downlink Control Information, DCI, signaling, the UL scheduling grant. The UL scheduling grant can indicate the network coding configuration set identifier, an index value of the target erasure correction code rate, and an identifier of the coding coefficients subset.

It will be appreciated that in case network coding is employed in the HARQ process, the network coding may serve as an outer erasure correction code while LDPC channel coding serves as an inner error correction code. The outer network coding placement within the LDPC channel coding processing chain will now be described. To this end, the UE may perform packet level rate matching before the inner LDPC channel coding function, as illustrated in FIG. 6, or after the inner LDPC channel coding function as illustrated in FIG. 7.

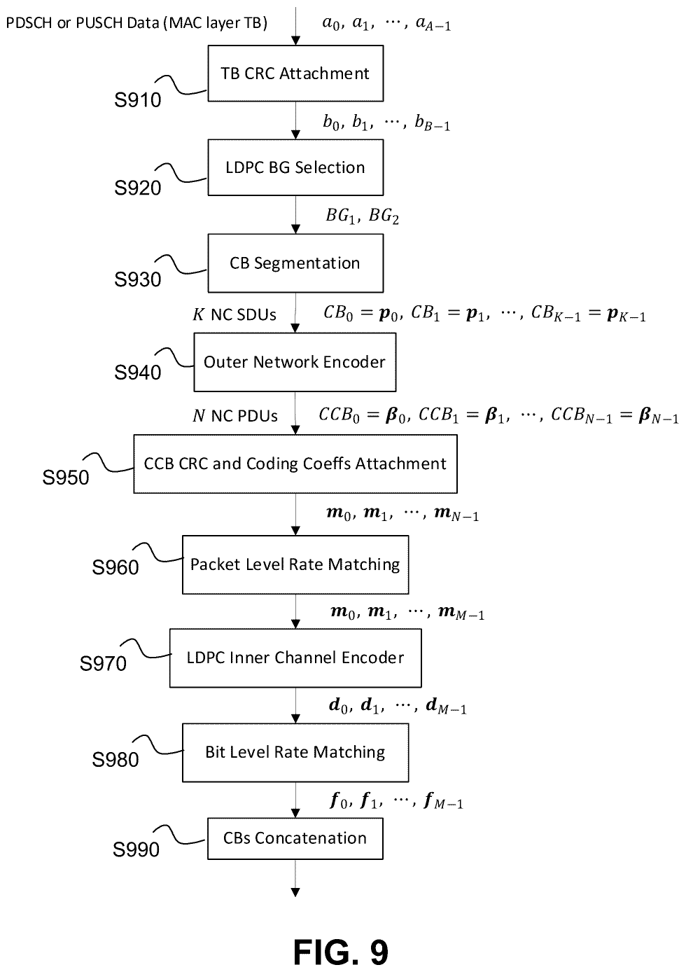

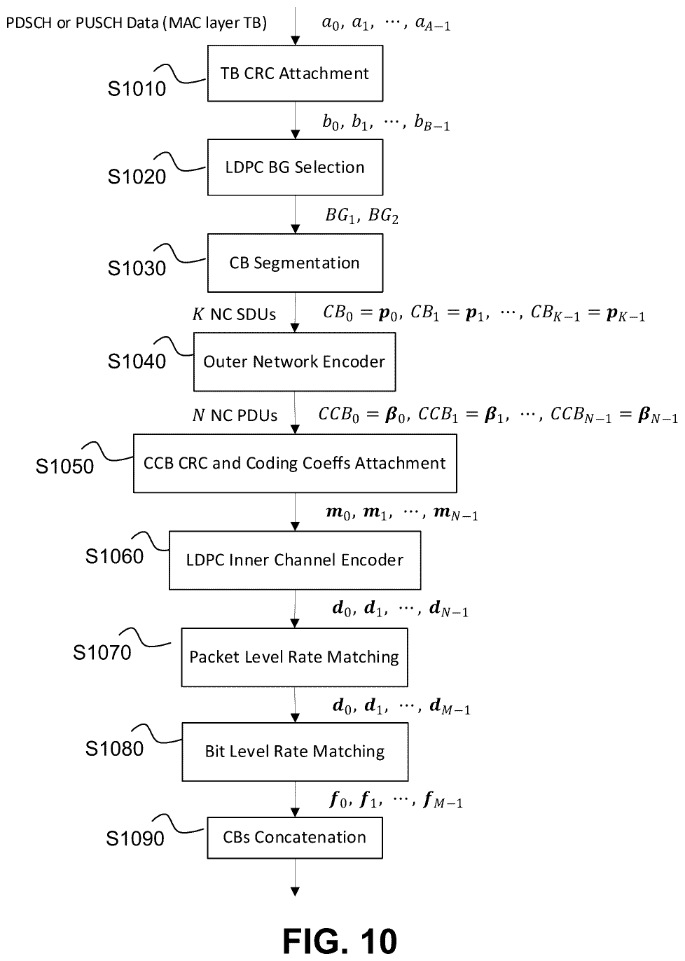

In FIG. 9 and FIG. 10, some of the processing steps are not changed and follow legacy system, these steps, which may be summarily described, include: the TB CRC attachment procedure (S910 and S1010), the LDPC inner channel coding procedure (S970 and S1060), the bit level rate matching procedure (S980 and S1080), and the CB concatenation procedure (S990 and S1090). On the other hand, new steps which may need to be introduced or legacy steps which may need enhancements due to the introduction of network coding, and that will be described in detail are:

LDPC Base Graph Selection (S920 and S1020).

CB Segmentation and Zero Padding (S930 and S1030).

Outer Network Encoding Operation, Coding Coeffs Attachment (S940 and S1040).

Outer Coded CB CRC Calculation and Attachment (S950 and S1050).

Packet Level Rate Matching (S960 and S1070).

The composite channel coding illustrated in FIGS. 9 and 10 is described for the uplink, but it will be understood that are equally applicable to the downlink. It is noted that since FIGS. 9 and 10 differ in the order of two steps-in FIG. 9, the packet level rate matching, S960, is performed before the LDPC inner channel encoder, S970, while the order is the opposite in FIG. 10—the steps of FIG. 10 will not be described as they are already described with reference to FIG. 9.

First, the method illustrated in FIG. 9 will be described.

First (and not illustrated in the figures), the UE determines a target erasure correction code rate and packet level Redundancy Version (RV).

Generally speaking, for the uplink transmission, the UE generates a set of candidate outer coded CBs. The set of candidate outer coded CBs can for example be based on the packet level redundancy version, which for instance can be determined based on a received scheduling grant, i.e. in the absence of an erasure correction mother code rate. In this case, during each (re)-transmission instant, the UE generates a new set of candidate outer coded CBs and then selects the outer coded CBs to transmit from the set of candidate outer coded CBs according to pre-determined role.

In a specific example, for the uplink transmission, i.e. PUSCH, the UE is configured to receive a target erasure correction code rate and packet level redundancy version identifier, which can be carried in new fields introduced in DCI format carrying the UL scheduling grant, as follows.

The UE is configured with one or more target erasure correction code rate values and packet level RVs. For example, the UE may be configured with a set of target erasure correction code rate values, e.g. in a list or a set. For example, the UE may be configured with a modified MCS table that indicates a suitable modulation order, target error correction code rate, and target erasure correction code rate. For example, the UE may be configured with a set of packet level RVs, e.g. in a set.

The UE receives a DCI scheduling grant and determines the target erasure correction code rate and the packet level RV. For example, the UE may receive new DCI signaling indicating the target erasure correction code rate within the UL scheduling grant. For example, the UE may receive a modified MCS index value that indicates a suitable modulation order, target error correction code rate, and target erasure correction code rate. For example, the UE may be configured to receive a legacy MCS index value or a modified MCS index value and use the indicated code rate as the effective code rate (R), where R=Rₚ*R_{b}. For example, the UE may receive new DCI signaling indicating the packet level RV identifier within the UL scheduling grant.

In one embodiment, the UE is configured with a target erasure correction code rate table or set, that includes a set of possible values for the target erasure correction code rate which may rely on the throughput, reliability, latency requirements. In this case, the UE may be configured through DCI scheduling grant parameters with a target erasure correction code rate index value, that is explicitly indicated through a field in the DCI signaling. For example, a DCI field within the UL scheduling grant in a codepoint of size ┌log₂ Q┐ bits are required to signal the target erasure correction code rate index value to the UE, as shown in Table 3.

TABLE 3
An example of target erasure correction code rate table or set.

| target erasure | target erasure |
|---|---|
| correction code | correction code |
| rate index value | rate (Rₚ) |
| 0 | Rₚ_{₀} |
| 1 | Rₚ_{₁} |
| . | . |
| . | . |
| . | . |
| Q − 1 | Rₚ_{_{Q − 1}} |

In one embodiment, the UE is configured with an MCS table that indicates a suitable modulation order, target error correction code rate, and target erasure correction code rate. For example, a DCI field, carrying the UL scheduling grant, of size ┌log₂ P┐ bits is required to signal the MCS index value to the UE, wherein P is the length of MCS table, e.g. as shown in Table 4.

TABLE 4
An example of a modified MCS table

| | | target error | target erasure |
|---|---|---|---|
| MCS index | Modulation | correction | correction code |
| value | Order (Qₘ) | code rate (R_{b}) | rate (Rₚ) |
| 0 | Qₘ_{₀} | R_{b}_{₀} | Rₚ_{₀} |
| 1 | Qₘ_{₁} | R_{b}_{₁} | Rₚ_{₁} |
| 2 | Qₘ_{₂} | R_{b}_{₂} | Rₚ_{₂} |
| 3 | Qₘ_{₃} | R_{b}_{₃} | Rₚ_{₃} |
| . | . | . | . |
| . | . | . | . |
| . | . | . | . |
| P − 1 | Qₘ_{_{P − 1}} | R_{b}_{_{P − 1}} | Rₚ_{_{P − 1}} |

In one embodiment, the UE is configured with legacy MCS table or a modified MCS table and use the indicated code rate in the MCS table or a modified MCS table as the effective code rate (R), where R=Rₚ*R_{b}. In this case, based on the uplink SRS, the network performs CSI measurements e.g. channel quality measurement, interference level measurement, then signal the appropriate MCS index value or a modified MCS index value with/without Rₚ index value to the UE within the DCI scheduling grant. For example, a target erasure correction code rate table or set, that includes a set of possible values for the target erasure correction code rate which may rely on the throughput, reliability, latency requirements. For example, the network could configure the UE to use a fixed target erasure correction code rate.

In one embodiment, the UE is configured with a number of packet level redundancy versions, e.g. with four packet level redundancy versions, where a packet level redundancy version identifier is signalled within the DCI grant for each initial transmission and possible subsequent retransmissions occasion. For example, a two-bit DCI field as illustrated in Table 2 may be used.

In one embodiment, the UE receives a target erasure correction code rate value, e.g. via PHY layer signaling in a DCI field within the UL scheduling grant. For example, a codepoint of bit-width length ┌log₂ Q┐ bits may be received which points into an element of the set of target erasure correction code rate values.

In one embodiment, the UE receives a packet level RV identifier, e.g. via new field introduced in a DCI format configured for the UL scheduling grant, which indicates an element from a set of packet level RV identifiers.

In step S920, the UE selects a LDPC Base Graph. For the uplink transmission, i.e., PUSCH, the UE performs LDPC BG selection based on one or more of the following: the TB payload size (A), target erasure correction code rate (Rₚ), and target error correction code rate (R_{b}), or a combination thereof.

For the initial transmission of TB payload data, to determine the maximum CB size, the UE performs LDPC BG selection based on one or more of the TB payload size size (A), target erasure correction code rate (Rₚ), and target error correction code rate (R_{b}), or a combination thereof. For example, the UE performs LDPC BG selection based on the TB payload size (A), target erasure correction code rate (Rₚ), and target error correction code rate (R_{b}). For example, the UE performs LDPC BG selection based on the TB payload size (A), and the effective code rate (R).

In one embodiment, the UE may determine the erasure correction mother code rate based on the selected base graph (BG), i.e., based on one or more of the following: the TB payload size (A), target erasure correction code rate (Rₚ), and target error correction code rate (R_{b}). For example, for BG1 with large CB size, the UE may be configured with a medium erasure correction mother code rate, e.g. 1/3, whereas for BG2 with small CB size, the UE may be configured with a low erasure correction mother code rate, e.g. 1/5.

In one embodiment, in an explicit indication, the UE is semi-statically configured with a fixed erasure correction mother code rate value, e.g. 1/5, that is determined e.g. based on QoS requirements, latency requirements, or reliability requirements, etc.

In one embodiment, the UE is configured to generate and transmit the outer coded CBs in an adaptive manner based on the indicated target erasure correction code rate without the use of an erasure correction mother code rate. In this case, during the initial transmission, the UE may transmit all or a subset of the generated outer coded CBs, e.g. the UE may sequentially transmit the determined number of outer coded CBs starting from the first systematic outer coded CB based on the indicated target erasure correction code rate and ignores the remaining outer coded CBS, whereas during a retransmission, the UE generates a new set of outer coded CBs for retransmission based on for example the signalled target erasure correction code rate and the utilized HARQ acknowledgment feedback. Such a technique can reduce the outer network encoding and decoding complexity significantly as only a linear combination of the erroneously received CBs are retransmitted. It is noted that there is only one packet level redundancy version with such a technique.

In one embodiment, the UE receives an erasure correction mother code rate value, e.g. via a DCI field signalled within the UL scheduling grant. For example, a codepoint of predetermined size may be received and points into an element within the erasure correction mother code rate values.

In one embodiment, the erasure correction code rate could be considered along with the TB payload data size and error correction code rate when selecting the appropriate LDPC BG. To this end, for the initial transmission and subsequent retransmissions of a TB payload data, to determine the maximum CB size, the UE performs LDPC BG selection based on the TB payload size (A), target erasure correction code rate (Rₚ) and error correction code rate (Rₚ). For example, a UE encodes each CB of the TB with either LDPC BG1 or BG2 according to the following: if A≤small (Threshold 1), or if A≤medium (Threshold 2) and Rₚ or R_{b}≤medium (Threshold 3), or if Rₚ or R_{b}≤low (Threshold 4), then LDPC BG2 is selected; otherwise, LDPC BG1 is selected.

The BG selection decision needs to be aligned between transmitter and receiver. Once a receiver decodes the DCI control information in the initial transmission, it knows the TB payload size, the erasure correction code rate (Rₚ) and error correction code rate (R_{b}). Therefore, the receiver can deduce which BG is used based on the above criteria. The TB payload size does not change between initial transmission and subsequent retransmissions, while Rₚ and R_{b} may change between initial transmission and subsequent retransmissions. Though a different BG selection decision could be made at the UE during subsequent retransmissions, once a BG is selected for the initial transmission of a given TB, it is used for the initial transmission and subsequent retransmissions, i.e. the BG does not change during the retransmissions of the same TB.

The UE can perform LDPC BG selection based on the TB payload size (A) and the effective code rate (R), where R=Rₚ*Rₚ. Therefore, a UE encodes each CB of the TB with either LDPC BG1 or BG2 according to the following: if A≤small (Threshold 1), or if A≤medium (Threshold 2) and R≤medium (Threshold 3), or if R≤low (Threshold 4), then LDPC BG2 is selected; otherwise, LDPC BG1 is selected.

In step S930, the UE performs CB Segmentation and Zero Padding. Generally speaking, the UE performs CB segmentation and zero padding based on one or more of the following: the TB payload size, including the TB CRC parity bits, CRC parity bits size, and the coding coefficients or coding coefficients index identifier size. This can for example be done as follows.

In a first sub-step, the UE may be configured with an MCS table.

In a second sub-step, the UE determines the total number of CBs within a TB based on one or more of the following: the TB payload size, including the TB CRC parity bits, maximum CB size of the selected BG, the CB CRC parity bits size, and the coding coefficients or coding coefficients index identifier size. For example, the UE determines the total number of CBs within a TB based on the TB payload size, including the TB CRC size, maximum CB size of the selected BG, the CB CRC parity bits size, and the coding coefficients or coding coefficients index identifier size.

Once a BG is selected, the TB is segmented into K source CBs (i.e., K NC SDUs constituting one network coding generation). The input bits to the CB segmentation are denoted by b=[b₀, b₁, . . . , b_{B-1}] where B is the number of bits in the TB payload (including the CRC bits). CB segmentation is performed based on the maximum CB size for the selected BG, denoted as k_{cb}. If the TB payload size B is not larger than the maximum CB size k_{cb} of the selected BG, the total number of code blocks is K=1, i.e., no CB segmentation and no CB CRC attachment is performed. In this case, the outer network coding function may be deactivated, e.g., works as a transparent mode network coding, and the total number of bits in the CB k′ is equal to the original TB payload size B.

In one embodiment, UE determines the total number of CBs within a TB (as in legacy system) based on the TB payload size (including the TB CRC size), maximum CB size of the selected BG, and the CB CRC parity bits size. In this case, if the TB payload size B is larger than the maximum CB size k_{cb} of the selected BG, the number of CBs within a TB is calculated as K=┌B/(k_{cb}−L)┐, where L=24 is the number of CB CRC bits, to be calculated and appended after the outer network coding function.

In one embodiment, UE determines the total number of CBs within a TB based on the TB payload size (including the TB CRC size), maximum CB size of the selected BG, the CB CRC parity bits size, and the coding coefficients or coding coefficients index identifier size. In this case, if the TB payload size B is larger than the maximum CB size k_{cb} of the selected BG, the number of CBs within a TB is calculated as K=┌B/(k_{cb}−O−L)┐, where L=24 is the number of CB CRC bits and O is the number of coding coefficients or coding coefficients index identifier bits.

In a third sub-step, the UE then determines the total number of bits in the TB payload after CB segmentation based on one or more of the following: the TB payload size, including the TB CRC parity bits size, the CBs CRC parity bits size, coding coefficients or coding coefficients index identifier size, and the total number of CBs within a TB. For example, the UE may perform a legacy procedure, i.e., the UE determines the total number of bits in the TB payload after CB segmentation based on the TB payload size, including the TB CRC size, the CBs CRC parity bits, and total number of CBs within a TB. For example, the UE determines the total number of bits in the TB payload after CB segmentation based on the TB payload size, including the TB CRC size and total number of CBs within a TB, without the CBs CRC parity bits size. For example, the UE determines the total number of bits in the TB payload after CB segmentation based on the TB payload size, including the TB CRC size, the CBs CRC parity bits size, and coding coefficients or coding coefficients index identifier size, total number of CBs within a TB. For example, the UE determines the total number of bits in the TB payload after CB segmentation based on the TB payload size, including the TB CRC size, and coding coefficients or coding coefficients index identifier size, total number of CBs within a TB.

UE determines the total number of bits in the TB payload after CB segmentation (as in legacy system) based on the TB payload size (including the TB CRC size), the CBs CRC parity bits, and total number of CBs within a TB. In this case, the total number of bits in the TB payload could be defined as B′=B+K*L.

In one embodiment, UE determines the total number of bits in the TB payload after CB segmentation based on the TB payload size (including the TB CRC size), without the CBs CRC parity bits. In this case, the total number of bits in the TB payload could be defined as B′=B.

In one embodiment, UE determines the total number of bits in the TB payload after CB segmentation based on the TB payload size (including the TB CRC size), the CBs CRC parity bits size, and coding coefficients or coding coefficients index identifier size, total number of CBs within a TB. In this case, the total number of bits in the TB payload could be defined as B′=B+K*O+K*L.

In one embodiment, UE determines the total number of bits in the TB payload after CB segmentation based on the TB payload size (including the TB CRC size), and coding coefficients or coding coefficients index identifier size, total number of CBs within a TB. In this case, the total number of bits in the TB payload could be defined as B′=B+K*O.

In a fourth sub-step, the UE then determines the BG matrix expansion factor, for example based on one or more of: the total number of bits within each CB, the number of information bit columns of the selected BG, and the CB CRC parity bits size.

In the legacy CB segmentation procedure, the UE determines the BG matrix expansion factor based on the total number of bits within each CB and the number of information bit columns of the selected BG. In this case, for a given TB size B, the number of information bit columns kb for the selected BG matrix is determined. Then, given k_{b}, the BG matrix expansion factor Z, is determined depending on whether the CB CRC parity bits are included when evaluating the total number of bits in the TB payload after CB segmentation.

The UE may perform a legacy CB segmentation procedure, when the CB CRC parity bits are included when evaluating the total number of bits in the TB payload after CB segmentation, the BG matrix expansion factor Z_{c} is determined by selecting the minimum Z_{c} value such that k_{b}×Z_{c}≥k′.

In one embodiment, when the CB CRC parity bits are not included when evaluating the total number of bits in the TB payload after CB segmentation, the BG matrix expansion factor Z_{c} is determined by selecting the minimum Z, value such that k_{b}×Z_{c}≥k′+L.

The UE determines the final CB size based on the selected LDPC BG and the BG matrix expansion factor, where further zero padding bits may be added at the end of each CB to match the configured CB size. In this case, the number of bits within each CB can finally be determined as follows: for BG1, k=22*Z_{c}, whereas for BG2, k=10*Z_{c}.

In a fifth sub-step, the UE determines the entries of each CB based on one or more of: the TB payload data bits within each CB, the zero padded CB CRC parity bits, the zero padded coding coefficients or coding coefficients index identifier, and any further zero padding bits added to match the configured CB size.

For example, the UE determines the entries of each CB based on the TB payload data bits within each CB, the zero padded CB CRC parity bits and any further zero padding bits added to match the configured CB size. For example, the UE determines the entries of each CB based on the TB payload data bits within each CB, the zero padded CB CRC parity bits, the zero padded coding coefficients or coding coefficients index identifier, and any further zero padding bits added to match the configured CB size. For example, the UE determines the entries of each CB based on the TB payload data bits within each CB and the further zero padding bits added to match the configured CB size before including the zero padded CB CRC parity bits. For example, the UE determines the entries of each CB based on the TB payload data bits within each CB, the zero padded coding coefficients or coding coefficients index identifier, and any further zero padding bits added to match the configured CB size before including the zero padded CB CRC parity bits.

The UE can determine the entries of each CB based on one or more of the TB payload data bits within each CB, the zero padded CB CRC parity bits, the zero padded coding coefficients or coding coefficients index identifier, and any further zero padding bits added to match the configured CB size. It is noted that the CB CRC calculation and attachment is deferred after the outer network coding function.

In one embodiment, the UE determines the entries of each CB based on the TB payload data bits within each CB, the zero padded CB CRC parity bits, and any further zero padding bits added to match the configured CB size. In this case, the first output CB after the CB segmentation and zero padding is denoted as CB₀=p₀=[p_{0,0}, p_{0,1}, . . . , p_{0,k-1}], where the first k′−L entries of p₀ are the first k′−L entries of the TB payload data b=[b₀, b₁, . . . , b_{B-1}], whereas the rest of the bits from bit index k′−L to k−1 are zero padded to match the configured CB size. It is noted that the CB CRC parity bits ρ₀=[ρ_{0,0}, ρ_{0,1}, . . . , ρ_{0,L-1}] location with entries from bit index k′−L to k′−1 are initially zero padded, whereas any extra zero padded bits may be added to match the configured CB size, i.e. the entries from bit index k′ to k−1 are zero padded to match the configured CB size. Therefore, in this case, the entries of the first CB is given as p₀=[p_{0,0}, p_{0,1}, . . . , p_{0,k′-L-1}, ρ_{0,0}, ρ_{0,1}, . . . , ρ_{0,L-1}, 0, . . . , 0].

In one embodiment, UE determines the entries of each CB based on the TB payload data bits within each CB and the further zero padding bits added to match the configured CB size, without including the zero padded CB CRC parity bits. In this case, the first output CB after the CB segmentation and zero padding is denoted as CB₀=p₀=[p_{0,0}, p_{0,1}, . . . , p_{0,k-L-1}], where the first k′ entries of po are the first k′ entries of the TB payload data b=[b₀, b₁, . . . , b_{B-1}], whereas the rest of the bits from bit index k′ to k−L−1 are zero padded to match the configured CB size before CB CRC attachment. Therefore, in this case, the entries of the first CB are given as p₀=[p_{0,0}, p_{0,1}, . . . , p_{0,k′-1}, 0, . . . , 0].

In one embodiment, UE determines the entries of each CB based on the TB payload data bits within each CB, the zero padded CB CRC parity bits, the zero padded coding coefficients or coding coefficients index identifier, and the further zero padding bits added to match the configured CB size. In this case, the first output CB after the CB segmentation and zero padding is denoted as CB₀=p₀=[p_{0,0}, p_{0,1}, . . . , p_{0,k-1}], where the first O entries of p₀ are the coding coefficients or coding coefficients index identifier, while the entries from index O to k′−L−1 of p₀ are the first k′−O−L entries of the TB payload data b=[b₀, b₁, . . . , b_{B-1}], whereas the bit entries from index k′−L to k′−1 are the appended zero padded CB CRC parity bits ρ₀=[ρ_{0,0}, ρ_{0,1}, . . . , ρ_{0,L-1}], while the rest of the bits from index k′ to k−1 are the extra zero padded bits added to match the configured CB size. Therefore, in this case, the entries of the first CB are given as

$${p}_{0} = [ {α}_{0 , 0} , {α}_{0 , 1} , … , {α}_{0 , O - 1} , {p}_{0 , 0} , {p}_{0 , 1} , … , {p}_{o , {k}^{′} - O - L - 1} , {ρ}_{0 , 0} , {ρ}_{0 , 1} , … , {ρ}_{0 , L -} , 0 , … , 0 ] .$$

In one embodiment, UE determines the entries of each CB based on the TB payload data bits within each CB, the zero padded coding coefficients or coding coefficients index identifier, and any further zero padding bits added to match the configured CB size before including the zero padded CB CRC parity bits. In this case, the first output CB after the CB segmentation and zero padding is denoted as CB₀=p₀=[p_{0,0}, p_{0,1}, . . . , p_{0,k-L-1}], where the first O entries of po are the zero padded coding coefficients or coding coefficients index identifier, while the entries from index O to k′−1 of p₀ are the first k′−O entries of the TB payload data b=[b₀, b₁, . . . , b_{B-1}], whereas the bit entries from index k′ to k−L−1 are the extra zero padded bits to match the configured CB size. Therefore, the entries of the first CB is given as p₀=[α_{0,0}, α_{0,1}, . . . , α_{0,O-1}, p_{0,0}, p_{0,1}, . . . , p_{0,k′-O-1}, 0, . . . , 0].

In step S650, the UE calculates and attaches an outer coded CB CRC.

The UE may be configured with an MCS index value and may calculate the CRC parity bits based on one or more of the outer coded CB entries (excluding the zero padded CB CRC parity bits and any extra zero padded bits added to match the configured CB size) and the coding coefficients or the coding coefficients index identifier.

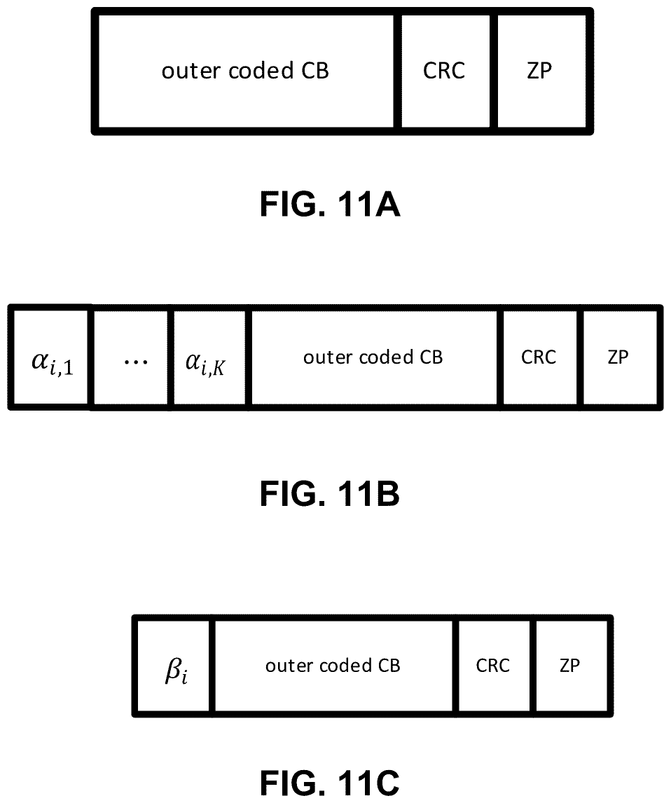

For example, if the configured CB segmentation considers the CRC parity bits size, the UE determines the CRC parity bits based on the outer coded CB entries, excluding the zero padded CB CRC parity bits and any extra zero padded bits added to match the configured CB size. The UE then replaces the zero padded CRC parity bits with the calculated CRC parity bits. FIG. 11A illustrates the resulting outer coded CB format.

For example, if the configured CB segmentation considers the CRC parity bits size, the UE determines the CRC parity bits based on the outer coded CB entries and the coding coefficients or coding coefficients index identifier, excluding the zero padded CRC parity bits and any extra zero padded bits added to match the configured CB size. The coding coefficients or coding coefficients index identifier are appended to the outer coded CB prior to CRC parity bits calculation and attachment. The UE then replaces the zero padded CRC parity bits with the calculated CRC parity bits. FIGS. 11B and 11C illustrate resulting outer coded CB formats.

For example, if the configured CB segmentation does not consider the CRC parity bits size, the UE determines the CRC parity bits based on the outer coded CB entries, excluding any extra zero padded bits added to match the configured CB size. The UE then appends the calculated CRC parity bits to the outer coded CB before the extra zero padded bits added to match the configured CB size.

For example, if the configured CB segmentation does not consider the CRC parity bits size, the UE determines the CRC parity bits based on the outer coded CB entries and the coding coefficients or coding coefficients index identifier, excluding any extra zero padded bits added to match the configured CB size. The coding coefficients or coding coefficients index identifier are appended to the outer coded CB prior to CB CRC parity bits calculation and attachment. The UE then appends the calculated CRC parity bits to the outer coded CB before the extra zero padded bits added to match the configured CB size.

Once the UE has replaced the zero padded coding coefficients or coding coefficients index identifier with the actual values within the outer coded CBs, a number of CRC parity bits are calculated and appended (or replaced with the zero padded CB CRC parity bits) to each of the N outer coded CBs resulting in m₀, m₁, . . . , m_{N-1} of size k bits each. More specifically, the resultant CRC codeword c(x)=cₖ₋₁x^{k-1}+cₖ₋₂x^{k-2} . . . +c₁x+c₀ with its L low order redundant parity bits (c₀, c₁, . . . , c_{L-1}) need to be divisible by the generator polynomial g(x). Therefore, for a CRC message m(x) of length k′−L bits, the CRC codeword is given by c(x)=m(x)*x^{L}+p(x), where the remainder p(x) is calculated such that m(x)*x^{L}=q(x)g(x)+p(x), where q(x) is the quotient produced by dividing c(x) by g(x). Alternatively, the CRC codeword can be written as c(x)=m(x)*x^{L}−m(x)*x mod g(x). Therefore, UE calculates the CRC parity bits based on one or more of the following: the outer coded CB entries (excluding the zero padded CB CRC parity bits and any extra zero padded bits added to match the configured CB size) and coding coefficients or coding coefficients index identifier entries.

In one embodiment, if the configured CB segmentation considers the CRC parity bits size, the UE determines the CRC parity bits based on the outer coded CB entries, excluding the zero padded CB CRC parity bits and any extra zero padded bits added to match the configured CB size. The UE then replaces the zero padded CB CRC parity bits with the calculated CB CRC parity bits. In this case, the first outer coded CB with the zero padded CB CRC is denoted as β₀=[β_{0,0}, β_{0,1}, . . . , β_{0,k-1}], while the first outer coded CB after CB CRC calculation and attachment is denoted m₀=[m_{0,0}, m_{0,1}, . . . , m_{0,k-1}] where [m_{0,0}, m_{0,1}, . . . , m_{0,k′-L-1}]=[β_{0,0}, β_{0,1}, . . . , β_{0,k′-L-1}], i.e. the first k′−L entries of m₀ are the first k′−L entries of β₀ corresponding to the TB payload data, whereas the rest of the bits of β₀ from bit index k′−L to k′−1 are the zero padded CB CRC parity bits. Therefore, the entries [m_{0,0}, m_{0,1}, . . . , m_{0,k′-L-1}] are used to calculate the CB CRC parity bits ρ₀=[ρ_{0,0}, ρ_{0,1}, . . . , ρ_{0,L-1}] where after zero padding resulting in m₀=[m_{0,0}, m_{0,1}, . . . , m_{0,k-1}], where the bit entries from index k′−L to k′−1 are the calculated and replaced CB CRC parity bits ρ₀, while the bits from index k′ to k−1 are the extra zero padded bits added to match the configured CB size. Therefore, in this case, the entries of the first outer coded CB after CB CRC calculation and attachment is given as m₀=[m_{0,0}, m_{0,1}, . . . , m_{0,k′-L-1}, ρ_{0,0}, ρ_{0,1}, . . . , ρ_{0,L-1}, 0, . . . , 0].

In one embodiment, if the configured CB segmentation considers the CRC parity bits size, the UE determines the CB CRC parity bits based on the outer coded CB entries, including the coding coefficients or coding coefficients index identifier entries, excluding the zero padded CB CRC parity bits and any extra zero padded bits added to match the configured CB size. The UE then replaces the zero padded CB CRC parity bits with the calculated CB CRC parity bits. In this case, the first outer coded CB with the zero padded coding coefficients or coding coefficients index identifier entries, and zero padded CB CRC entries is given as β₀=[β_{0,0}, β_{0,1}, . . . , β_{0,k-1}], where first the zero padded coding coefficients or coding coefficients index identifier entries are replaced with the actual coding coefficients or coding coefficients index identifier entries. Then, after CB CRC calculation and replacement, the resultant first outer coded CB is given as m₀=[m_{0,0}, m_{0,1}, . . . , m_{0,k-1}], where the first O entries of m₀ are the actual coding coefficients or coding coefficients index identifier entries, while the entries from index O to k′−L−1 of m₀ are the first k′−O−L entries of the outer coded CB β₀ corresponding to the TB payload data, i.e. denoted [m_{0,0}, m_{0,O+1}, . . . , m_{0,k′-L-1}]=[β_{0,O}, β_{0,O+1}, . . . , β_{0,k′-L-1}]. On the other hand, the bit entries from index k′−L to k′−1 are the calculated and replaced CB CRC parity bits ρ₀, while the rest of the bits from index k′ to k−1 are the extra zero padded bits added to match the configured CB size. The first outer coded CB entries [m_{0,0}, m_{0,1}, . . . , m_{0,k′-L-1}] are used to calculate the CRC parity bits ρ₀=[ρ_{0,0}, p_{0,1}, . . . , ρ_{0,L-1}]. Therefore, in this case, the entries of the first outer coded CB is given as m₀=[α_{0,0}, α_{0,1}, . . . , α_{0,O-1}, m_{0,O}, m_{0,O+1}, . . . , m_{0,k′-L-1}, ρ_{0,0}, ρ_{0,1}, . . . , ρ_{0,L-1}, 0, . . . , 0].

In one embodiment, if the configured CB segmentation does not consider the CRC parity bits size, the UE determines the CRC parity bits based on the outer coded CB entries, excluding any extra zero padded bits added to match the configured CB size, then append the calculated CRC parity bits to the outer coded CB before adding any extra zero padded bits added to match the configured CB size. In this case, the first outer coded CB before CB CRC attachment is given as β₀=[β_{0,0}, β_{0,1}, . . . , β_{0,k-L-1}], while the first outer coded CB after CB CRC calculation and attachment is given as m₀=[m_{0,0}, m_{0,1}, . . . , m_{0,k-1}], where [m_{0,0}, m_{0,1}, . . . , m_{0,k′-1}]=[β_{0,0}, β_{0,1}, . . . , β_{0,k′-1}], i.e. the first k′ entries of m₀ are the first k′ entries of β₀ corresponding to the TB payload data, whereas the bits of β₀ from bit index k′ to k−L−1 are the extra zero padded bits added to match the configured CB size before CB CRC attachment. The entries [m_{0,0}, m_{0,1}, . . . , m_{0,k′-1}] are used to calculate the CB CRC parity bits ρ₀=[ρ_{0,0}, ρ_{0, 1}, . . . , p_{0,L-1}]. Therefore, in this case, the entries of the first outer coded CB after the CB CRC calculation and attachment is given as m₀=[m_{0,0}, m_{0,1}, . . . , m_{0,k′-1}, ρ_{0,0}, ρ_{0,1}, . . . , ρ_{0,L-1}, 0, . . . , 0].

In one embodiment, if the configured CB segmentation does not consider the CRC parity bits size, the UE determines the CRC parity bits based on the outer coded CB entries, including the coding coefficients or coding coefficients index identifier, excluding any extra zero padded bits added to match the configured CB size, then append the calculated CB CRC parity bits to the outer coded CB. In this case, the first outer coded CB is given as β₀=[β_{0,0}, β_{0,1}, . . . , β_{0,k-L-1}], while the first outer coded CB after the coding coefficients or coding coefficients index identifier replacement and CB CRC attachment is given as m₀=[m_{0,0}, m_{0,1}, . . . , m_{0,k-1}], where the first 0 entries of m₀ are the coding coefficients or coding coefficients index identifier, while the entries from index O to k′−1 of m₀ are the first k′−0 entries of the outer coded CB β₀ corresponding to the TB payload data, i.e. denoted [m_{0,O}, m_{0,O+1}, . . . , m_{0,k′-1}]=[β_{0,O}, β_{0,O+1}, . . . , β_{0,k′-1}]. The bit entries from index k′ to k′+L−1 are the calculated and appended CB CRC parity bits ρ₀, while the rest of the bits from index k′+L to k−1 are the extra zero padded bits added to match the configured CB size. The entries [m_{0,0}, m_{0,1}, . . . , m_{0,k′-L-1}] are used to calculate the CB CRC parity bits ρ₀=[ρ_{0,0}, ρ_{0,1}, . . . , ρ_{0,L-1}]. Therefore, the entries of the first outer coded CB is given as m₀=[α_{0,0}, α_{0,1}, . . . , α_{0,-O-1}, m_{0,0}, m_{0,O+1}, . . . , m_{0,k′-1}, ρ_{0,0}, ρ_{0,1}, . . . , ρ_{0,L-1}, 0, . . . , 0].

Once the outer coded CB CRC parity bits are calculated and appended to each of the N transmitted outer coded CBs m₀, m₁, . . . , m_{N-1}, these message outer coded CBs are passed to the packet level rate matching function resulting in m₀, m₁, . . . , m_{M-1}.

In step S960, the UE performs packet level rate matching.

The UE generates a fixed number of redundant outer coded CBs according to a configured erasure correction mother code rate, e.g. determined based on the received DCI grant. The UE then performs packet level rate matching function to select a subset of these outer coded CBs for PUSCH data transmission, e.g. based on a fixed pre-determined rule.

In a first sub-step, the UE determines the erasure correction mother code rate explicitly or implicitly. The UE can determine the erasure correction code rate explicitly or implicitly in different ways.

The UE may determine the erasure correction mother code rate based on the selected base graph (BG), i.e. based on the TB payload size, target erasure correction code rate, and error correction code rate.

The UE may receive signaling, e.g. via new DCI signaling, indicating which erasure correction mother code rate to select from one or more pre-configured values of erasure correction mother code rates.

The UE may be semi-statically configured with a fixed erasure correction mother code rate.

The UE may autonomously select, e.g. based on QoS requirements, erasure correction mother code rate from pre-configured values.

The UE may determine erasure correction mother code rate based on pre-configured association between maximum number of HARQ retransmissions and erasure correction mother code rate.

In a second sub-step, the UE determines the number of outer coded CBs of the packet level mother code based on the number of source CBs and erasure correction mother code rate, where a ceiling or flooring function may be used to ensure that the number of outer coded CBs of the packet level mother code is an integer value.

In a third sub-step, the UE generates the packet level mother code based on the source CBs, the determined number of outer coded CBs of the packet level mother code, and the indicated generator matrix. The UE then selects the set of candidates outer coded CBs for the current transmission based on the received packet level RV.

The UE can generate the packet level mother code as described with reference to step S320.

In a fourth sub-step, the UE determines the number of outer coded CBs to transmit based on the number of source CBs and target erasure correction code rate, where a ceiling or flooring function may be used to ensure that the number of outer coded CBs to transmit is an integer value.

In a fifth sub-step, the UE selects the determined number of outer coded CBs to transmit from the set of candidates outer coded CBs based on the characteristics (e.g. importance) of the outer coded CBs.

For example, the UE may sequentially transmit the determined number of outer coded CBs based on the indicated packet level RV starting from the first systematic outer coded CB.

For example, the UE may transmit the determined outer coded CBs based on the characteristics (e.g. importance) of the outer coded CBs. For example, the UE may transmit a systematic outer coded CBs, less innovative outer coded CBs, more innovative outer coded CBs, or a combination thereof.

For example, based on the utilized HARQ feedback technique, the UE may construct the outer coded CBs to transmit with a specific characteristic (e.g. importance) to guarantee accumulations of innovative outer coded CBs. For example, for the first HARQ transmission, the UE may transmit systematic outer coded CBs and a first set of redundant outer coded CBs, and for the second HARQ retransmission, the UE may transmit less innovative outer coded CBs, a second set of redundant outer coded CBs, etc. the UE may assign a starting packet location for each (re)-transmission occasion, i.e. packet level RV from the generated packet level mother code. In this case, the UE may transmit the outer coded CBs starting from the indicated packet level RV identifier. This is to guarantee that at each (re)-transmission occasion indicated via the packet level RV identifier, new set of innovative outer coded CBs are being transmitted.

In a sixth sub-step, the UE performs the inner LDPC channel encoding function for the selected outer coded CBs.

The packet level rate matching step includes two distinct steps, determination of the number of outer coded CBs to transmit, and selection of the outer coded CBs to transmit, as described with reference to step S340.

For the downlink (PDSCH) scenario, the UE determines the target erasure correction code rate. For the downlink transmission, when network coding is applied at the PHY layer, the UE can measure and report the erasure correction code rate to the network. Alternatively, the outer network (erasure correction) code rate is signalled to the UE.

The UE can measure the erasure correction code rate according to a configured channel state information reference signal (CSI-RS) and/or channel state information interference measurements (CSI-IM). The UE then reports the erasure correction code rate index value to the network within the uplink control information (UCI). Alternatively, the UE may be configured to use a modified CQI table, where each reported CQI index value indicates the appropriate modulation order, error correction code rate, and erasure correction code rate.

In a first sub-step, the UE receives initial configuration information and is configured with one or more of target erasure correction code rates.

In a second sub-step, the UE performs CSI measurements, e.g. the channel quality and interference level, and then reports the target erasure correction code rate via UCI.

For example, the UE reports a target erasure correction code rate index value to the network within the UCI.

For example, the UE reports a modified CQI index value to the network within the UCI, where each modified CQI index value indicates an appropriate modulation order, error correction code rate, and target erasure correction code rate.

In one embodiment, the UE reports a target erasure correction code rate index value in UCI. In this case, based on the downlink CSI-RS and/or CSI-IM, the UE performs CSI measurements based on radio conditions, e.g. channel quality measurement, interference level measurement, then reports the target erasure correction code rate index value to the network within the UCI. For example, a UCI field in a codepoint of size ┌log₂ O┐ bits are required by the UE to report the target erasure correction code rate index value to the network, as illustrated in Table 6.

TABLE 6
An example of target erasure correction code rate table or set.

| target erasure correction | target erasure correction |
|---|---|
| code rate index value | code rate (Rₚ) |
| 0 | Rₚ_{₀} |
| 1 | Rₚ_{₁} |
| . | . |
| . | . |
| . | . |
| O − 1 | Rₚ_{_{O − 1}} |

In one embodiment, the UE may be configured to report a modified CQI index value that indicates a suitable modulation order, error correction code rate (R_{b}), and target erasure correction code rate (Rₚ). In this case, the assumption is that the UE is configured with multiple modified CQI tables, where each CQI index value indicates a modulation order, error correction code rate (R_{b}), and target erasure correction code rate (Rₚ). For example, an erasure correction code rates (Rₚ) column could be added to legacy CQI tables, as illustrated in Table 7 hereafter. The modified CQI table could be configured based on the use case requirements of reliability, latency, or throughput. In this case, the parameter of cqi-Table in CSI-ReportConfig will configure which modified CQI table should be used for CQI calculation.

In one embodiment, the UE may be configured to report a legacy CQI index value or a modified CQI index value and use the indicated code rate in the CQI table as the effective code rate (R), where R=Rₚ*R_{b}. In this case, based on the downlink CSI-RS, the UE performs CSI measurements, e.g. channel quality measurement, interference level measurement, then reports the appropriate CQI index value and Rₚp index value to the network within the UCI. For example, a UCI field in a codepoint of size ┌log₂ G┐ bits are required for the UE in order to signal the modified CQI index value to the network, as illustrated in Table 7.

TABLE 7
An example of a modified CQI table for a specific use case

| CQI index | Modulation | | |
|---|---|---|---|
| value | order (Qₘ) | R_{b} | Rₚ |
| 0 | Out of Range | Out of Range | Out of Range |
| 1 | Qₘ_{₀} | R_{b}_{₀} | Rₚ_{₀} |
| 2 | Qₘ_{₁} | R_{b}_{₁} | Rₚ_{₁} |
| 3 | Qₘ_{₂} | R_{b}_{₂} | Rₚ_{₂} |
| 4 | Qₘ_{₃} | R_{b}_{₃} | Rₚ_{₃} |
| . | . | . | . |
| . | . | . | . |
| . | . | . | . |
| G | Qₘ_{_{G − 1}} | R_{b}_{_{G − 1}} | Rₚ_{_{G − 1}} |

Similar to what has been described herein with reference to the determination of the target erasure correction code rate and the packet level RV, the UE may be configured with a target erasure correction code rate explicitly via a list or table as illustrated in Table 6, or implicitly via a new CQI table as illustrated in Table 7. In addition, the UE may be configured with a packet level RV set as illustrated in Table 5. Furthermore, the UE receives an indication for target erasure correction code rate, and packet level RV through new DCI fields within the UL scheduling grant.

In a third sub-step, the UE receives a DCI scheduling grant and determines the target erasure correction code rate value. For example, the UE receives new field in DCI signaling indicating the target erasure correction code rate. For example, the UE receives indication of target erasure correction code rate via MCS field in DCI which may point to a new/modified MCS table.

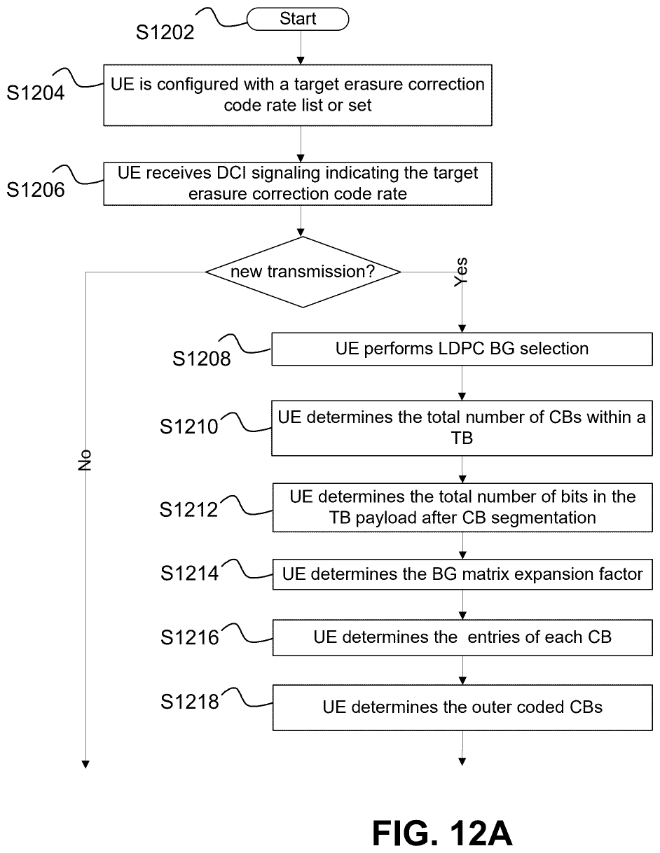

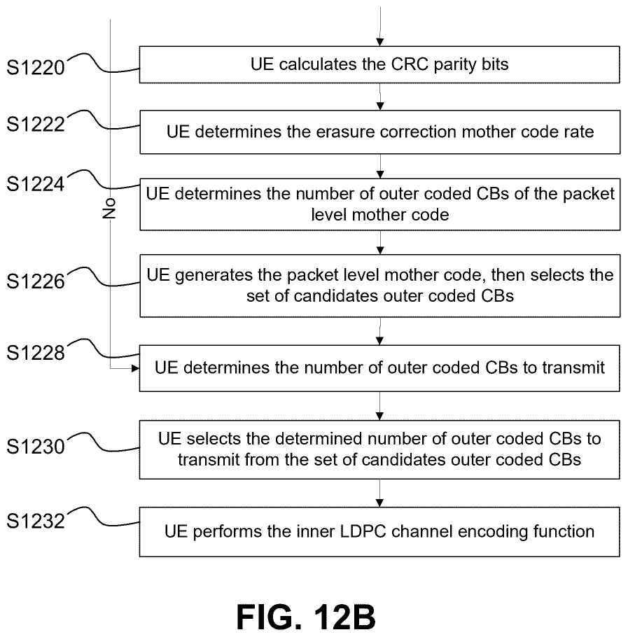

FIG. 12 (made up of FIGS. 12A and 12B) illustrates a flowchart of a method according to an embodiment of the present principles.

The method starts in step S1202.

In step S1204, the UE is configured with a target erasure correction code rate list or set.

In step S1206, the UE receives DCI signaling indicating the target erasure correction code rate.

In case the upcoming transmission is new, i.e., initial transmission, the method continues in step S1208; otherwise, the method continues in step S1228.

In step S1208, the UE performs LDPC BG selection based on the TB payload size (A), the target erasure correction code rate (Rₚ) and the error correction code rate (R_{b}).

The UE encodes each CB of the TB with either LDPC BG1 or BG2, for example as follows: if A≤small (Threshold 1), or if A≤medium (Threshold 2) and Rₚ or R_{b}≤medium (Threshold 3), or if Rₚ or R_{b}≤low (Threshold 4), then LDPC BG2 is selected; otherwise, LDPC BG1 is selected.

In step S1210, the UE determines the total number of CBs within a TB based on the TB payload size, including the TB CRC size, maximum CB size of the selected BG, the CB CRC parity bits size, and the coding coefficients index identifier size.

In step S1212, the UE determines the total number of bits in the TB payload after CB segmentation based on the TB payload size, including the TB CRC size and total number of CBs within a TB, without the CBs CRC parity bits size.

In step S1214, the UE determines the BG matrix expansion factor based on the following: the total number of bits within each CB, the number of information bit columns of the selected BG, and the CB CRC parity bits size.

In step S1216, the UE determines the entries of each CB based on the TB payload data bits within each CB, the zero padded CB CRC parity bits and any further zero padding bits added to match the configured CB size.

In step S1218, the UE determines the outer coded CBs before replacing the CRC parity bits.

In step S1220, the UE calculates the CRC parity bits based on the outer coded CB entries (excluding the zero padded CB CRC parity bits and any extra zero padded bits added to match the configured CB size) and coding coefficients index identifier.

If the configured CB segmentation considers the CRC parity bits size, the UE determines the CRC parity bits based on the outer coded CB entries, excluding the zero padded CB CRC parity bits and any extra zero padded bits added to match the configured CB size. The UE then replaces the zero padded CRC parity bits with the calculated CRC parity bits.

In step S1222, the UE determines the erasure correction mother code rate based on the selected BG, i.e., based on the TB payload size, erasure correction code rate, and error correction code rate.

In step S1224, the UE determines the number of outer coded CBs of the packet level mother code based on the number of source CBs and erasure correction mother code rate, where a ceiling or flooring function may be used to ensure that the number of outer coded CBs of the packet level mother code is an integer value.

In step S1226, the UE generates the packet level mother code based on the source CBS, the determined number of outer coded CBs of the packet level mother code, and the indicated generator matrix. The UE then selects the set of candidates outer coded CBs for the current transmission based on the received packet level RV.

In step S1228, the UE determines the number of outer coded CBs to transmit based on the number of source CBs and target erasure correction code rate, where a ceiling or flooring function may be used to ensure that the number of outer coded CBs to transmit is an integer value.

In step S1230, the UE selects the determined number of outer coded CBs to transmit from the set of candidates outer coded CBs based on the order the outer coded CBs are generated. For example, the UE may sequentially transmit the determined number of outer coded CBs based on the indicated packet level RV starting from the first systematic outer coded CB.

in step S1232, the UE performs the inner LDPC channel encoding function for the selected outer coded CBs.

Summing up the third embodiment, it is directed to a UE that performs LDPC BG selection based on a TB payload size, a target erasure correction code rate and an error correction code rate, low-density parity check code, determines a total number of CBs within a TB based on the TB payload size, a maximum CB size of the selected BG, a CB parity bits size, and a coding coefficients index identifier size, determines a total number of bits in the TB payload after CB segmentation based on the TB payload size and the total number of CBs within the TB without the CBs parity bits size, determines a BG matrix expansion factor based on a total number of bits within each CB, a number of information bit columns of the selected BG, and the CB parity bits size, determines entries of each CB based on the TB payload data bits within each CB, and zero padded CB parity bits, determines outer coded CBs, calculates parity bits based on the outer coded CBs, determines an erasure correction mother code rate based on the TB payload size, the target erasure correction code rate, and the error correction code rate, determines a number of outer coded CBs of a packet level mother code based on a number of source CBs and the erasure correction code rate, generates the packet level mother code based on the source CBs, the determined number of outer coded CBs of the packet level mother code, and the indicated generator matrix, selects a set of candidates outer coded CBs for a current transmission based on a received packet level redundancy version, RV, determines a number of outer coded CBs to transmit based on the number of source CBs and the target erasure correction code rate, selects the determined number of outer coded CBs to transmit from the set of candidates outer coded CBs based on a generation order of the outer coded CBs, performs inner channel encoding for the selected outer coded CBs, and transmits the encoded outer coded CBs.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method in a wireless transmit/receive unit, WTRU, the method comprising:
determining a set of candidate outer coded code blocks, CBs, based on a determined packet level redundancy version, RV, for a transmission, wherein each outer coded CB is a different linearly independent combination of a set of source CBs, a source CB being a segment of a transport block;
selecting a determined number of outer coded CBs to transmit, the outer coded CBs selected from the set of candidate outer coded CBs resulting from a generated packet level mother code; and
transmitting the selected outer coded CBs.

2. The method of claim 1, wherein the packet level RV is based on a received uplink, UL, scheduling grant for the transmission.

3. The method of claim 2, further comprising receiving the UL scheduling grant, wherein the UL scheduling grant indicates at least one of a network coding configuration set identifier, a target erasure correction code rate index value, and a packet level redundancy version identifier.

4. The method of claim 3, wherein the UL scheduling grant is received via downlink control information, DCI, signaling.

5. The method of claim 1, further comprising determining the number based on a number of source CBs in the set and a target erasure correction code rate.

6. The method of claim 1, wherein the outer coded CBs to transmit are selected from the set of candidates outer coded CBs according to their respective order sequence numbers.

7. The method of claim 1, further comprising, before the transmitting, providing the selected outer coded CBs to transmit to inner channel coding.

8. The method of claim 1, further comprising a prior configuration step in which the WTRU is configured with multiple sets of network coding configurations.

9. The method of claim 8, wherein each set of network coding configuration include at least one of an identifier of the configuration set, an erasure correction mother code rate value, a generator matrix of coding coefficients, a packet level redundancy version set, where for each packet level redundancy version, one or more identifiers of the corresponding coding coefficient rows, and one or more identifiers of coding coefficient columns, and a target erasure correction code rate list or set.

10. The method of claim 1, further comprising, on condition that the transmission is an initial transmission:
generating the packet level mother code, wherein the generating comprises:
determining a number of outer coded CBs to generate based on a number of source CBs in the set for the transmission and an erasure correction mother code rate; and
generating the determined number of outer coded CBs using a generator matrix associated with a network coding configuration set indicated in a received UL scheduling grant.

11. The method of claim 10, further comprising assigning respective order sequence numbers to the generated outer coded CBs of the packet level mother code.

12. The method of claim 11, wherein each order sequence number is determined as an order sequence number of a row of coding coefficients used to generate the outer coded CB.

13. The method of claim 1, further comprising determining the packet level RV for the transmission.

14. A wireless transmit/receive unit, WTRU, comprising at least one processor configured to:
determine a set of candidate outer coded code blocks, CBs, based on a determined packet level RV for a transmission, wherein each outer coded CB is a different linearly independent combination of a set of source CBs, a source CB being a segment of a transport block;
select a determined number of outer coded CBs to transmit, the outer coded CBs selected from the set of candidate outer coded CBs resulting from a generated packet level mother code; and
transmit the selected outer coded CBs.

15. The WTRU of claim 14, wherein the packet level RV is based on a received uplink, UL, scheduling grant for the transmission.

16. The WTRU of claim 14, wherein the at least one processor is further configured to determine the number based on a number of source CBs in the set and a target erasure correction code rate.

17. The WTRU of claim 14, wherein the at least one processor is further configured to select the outer coded CBs to transmit from the set of candidates outer coded CBs according to their respective order sequence numbers.

18. The WTRU of claim 14, wherein the at least one processor is further configured to, on condition that the transmission is an initial transmission:
generate the packet level mother code, wherein the generating comprises:
determine a number of outer coded CBs to generate based on a number of source CBs in the set for the transmission and an erasure correction mother code rate; and
generate the determined number of outer coded CBs using a generator matrix associated with a network coding configuration set indicated in a received UL scheduling grant.

19. The WTRU of claim 18, wherein the at least one processor is further configured to assign respective order sequence numbers to the generated outer coded CBs of the packet level mother code.

20. The WTRU of claim 19, wherein the at least one processor is further configured to determine each order sequence number as an order sequence number of a row of coding coefficients used to generate the outer coded CB.
